(19) United States
(12) Patent Application Publication
(10) Pub. No.: US 2025/0212069 A1
(43) Pub. Date: Jun. 26, 2025

(54) DATA PROCESSING METHOD AND TERMINAL DEVICE

(71) Applicant: HUAWEI TECHNOLOGIES CO., LTD., Shenzhen (CN)

(72) Inventors: Qiankun LI, Shanghai (CN); Zhiyuan HOU, Shanghai (CN); Ao GUO, Shanghai (CN); Zhifeng WANG, Shanghai (CN); Zijian SUI, Shenzhen (CN)

(21) Appl. No.: 19/078,562

(22) Filed: Mar. 13, 2025

Related U.S. Application Data
(63) Continuation of application No. PCT/CN2023/116547, filed on Sep. 1, 2023.

(30) Foreign Application Priority Data
Sep. 14, 2022 (CN) 202211117946.7

(51) Int. Cl. H04W 36/00; H04W 36/08; H04W 64/00

(52) U.S. Cl. CPC H04W 36/0061; H04W 36/08; H04W 64/00

(57) ABSTRACT

This application provides a data processing method and a terminal device. One example method includes: The terminal device receives, from a server, a first cellular cell set corresponding to a first specific scenario; and when identifying, based on cell information of a plurality of cells on which the terminal device camps, that the terminal device continuously passes through m first areas, the terminal device may determine that the terminal device is in the first specific scenario, and then may report, to the server, cell information of a plurality of cells on which the terminal device camps after determining that the terminal device is in the first specific scenario.

### CROSS-REFERENCE TO RELATED APPLICATIONS

This application is a continuation of International Application No. PCT/CN2023/116547, filed on Sep. 1, 2023, which claims priority to Chinese Patent Application No. 202211117946.7, filed on Sep. 14, 2022. The disclosures of the aforementioned applications are hereby incorporated by reference in their entireties.

### TECHNICAL FIELD

This application relates to the field of communication technologies, and in particular, to a data processing method and a terminal device.

### BACKGROUND

With rapid development of communication technologies, a terminal device may perform communication in different specific scenarios. However, in a process in which the terminal device performs communication in different specific scenarios, communication experience may poor. The following uses an example in which a specific scenario is a subway scenario for description.

As one of daily travel tools, a subway covers a large area and is convenient and fast. Therefore, the subway has a characteristic of dense population. However, because the subway is usually located underground, and related facilities such as a wireless communication network or a wired communication network deployed by an operator are imperfect, when a user uses a terminal device (for example, a mobile phone) to perform communication in the subway, problems such as a weak signal and application (App) freezing easily occur. In view of this, it is required to identify in advance whether the terminal device is in the subway scenario, to accurately optimize in time communication of the terminal device in the subway scenario in a targeted manner.

For the subway scenario, an identification manner is constructing a speed change model in a subway running process, and the terminal device may identify, based on the speed change model, whether the terminal device is in the subway scenario. The solution specifically includes: A computing device (for example, a terminal device or another device) may perform feature extraction on moving track data of a terminal device in a subway, to obtain a speed feature, and perform training and learning based on the speed feature, to obtain a speed change model for identifying the subway scenario; and then the terminal device identifies, based on the speed change model and real-time moving track data of the terminal device, whether the terminal device is currently in the subway scenario.

However, in the foregoing identification manner, when the speed change model is used for identification, there is a misidentification probability, and another transport tool may be identified as a subway. In addition, the terminal device needs to be in the subway scenario for a period of time to complete real-time moving track data collection before performing identification, causing a specific identification delay.

In conclusion, how to improve accuracy and timeliness of identifying a specific scenario by a terminal device becomes an urgent problem to be resolved.

### SUMMARY

This application provides a data processing method and a terminal device, to improve accuracy and timeliness of identifying a specific scenario by the terminal device.

According to a first aspect, an embodiment of this application provides a data processing method, and the method may be applied to a terminal device. In the method, the terminal device may first receive, from a server, a first cellular cell set corresponding to a first specific scenario. The first specific scenario includes n first areas, n is an integer greater than or equal to 2, and the first cellular cell set includes cell information of a plurality of cells in each of the n first areas. When identifying, based on cell information of a plurality of cells on which the terminal device camps, that the terminal device continuously passes through m first areas, the terminal device may determine that the terminal device is in the first specific scenario, where m is an integer greater than or equal to 2. Then, the terminal device may report, to the server, cell information of a plurality of cells on which the terminal device camps after determining that the terminal device is in the first specific scenario.

In the foregoing design, when identifying, based on the cell information of the plurality of cells on which the terminal device camps, that the terminal device continuously passes through the m first areas, the terminal device can accurately determine in time that the terminal device is in the first specific scenario, so that the terminal device may report, to the server for summarization, the cell information of the plurality of cells on which the terminal device camps in the first specific scenario. In this way, any terminal device may accurately identify in time, based on cell information of a plurality of cells in an area corresponding to a specific scenario (for example, a second specific scenario) obtained by the server through summarization, whether the terminal device is in the second specific scenario. This can help improve accuracy and timeliness of identifying a specific scenario by the terminal device.

In a possible design, the determining that the terminal device is in the first specific scenario includes:
determining a first movement feature of the terminal device; and
when identifying, based on the cell information of the plurality of cells on which the terminal device camps, that the terminal device continuously passes through the m first areas, and the first movement feature matches a movement feature of the terminal device in the first specific scenario, determining that the terminal device is in the first specific scenario.

In the foregoing design, to more accurately identify whether the terminal device is in the first specific scenario, when identifying, based on the cell information of the plurality of cells on which the terminal device camps, that the terminal device continuously passes through the m first areas, the terminal device may perform comprehensive identification with reference to the first movement feature of the terminal device, to improve accuracy of identifying a specific scenario by the terminal device.

In a possible design, after the reporting, to the server, cell information of a plurality of cells on which the terminal device camps after determining that the terminal device is in the first specific scenario, the method further includes:
receiving a second cellular cell set from the server, where the second cellular cell set includes cell information of a plurality of cells in an area corresponding to the second specific scenario;
obtaining cell information of a first cell on which the terminal device currently camps; and
when the second cellular cell set includes the cell information of the first cell, determining that the terminal device is in the second specific scenario.

In the foregoing design, because the second cellular cell set corresponding to the second specific scenario includes the cell information of the plurality of cells in the area corresponding to the second specific scenario, after obtaining the cell information of the first cell on which the terminal device currently camps, and when determining that the second cellular cell set includes the cell information of the first cell, the terminal device may accurately determine in time that the terminal device is in the second specific scenario.

In a possible design, the determining that the terminal device is in the second specific scenario includes:
determining a current physical location of the terminal device; and
when the second cellular cell set includes the cell information of the first cell, and the physical location belongs to the area corresponding to the second specific scenario, determining that the terminal device is in the second specific scenario.

In the foregoing design, the terminal device performs comprehensive identification based on the cell information of the first cell on which the terminal device currently camps and with reference to the current physical location of the terminal device. This can help improve accuracy of identifying a specific scenario by the terminal device.

In a possible design, the determining that the terminal device is in the second specific scenario includes:
determining a current second movement feature of the terminal device; and
when the second cellular cell set includes the cell information of the first cell, and the second movement feature matches a movement feature of the terminal device in the second specific scenario, determining that the terminal device is in the second specific scenario.

In the foregoing design, the terminal device performs comprehensive identification based on the cell information of the first cell on which the terminal device currently camps and with reference to the current movement feature of the terminal device. This can help improve accuracy of identifying a specific scenario by the terminal device.

In a possible design, the determining that the terminal device is in the second specific scenario includes:
determining first duration in which the terminal device camps on the first cell; and
when the second cellular cell set includes the cell information of the first cell, and the first duration is greater than a first duration threshold, determining that the terminal device is in the second specific scenario.

In the foregoing design, the terminal device performs comprehensive identification based on the cell information of the first cell on which the terminal device currently camps and with reference to the first duration in which the terminal device camps in the first cell. This can help improve accuracy of identifying a specific scenario by the terminal device.

In a possible design, after the determining that the terminal device is in the second specific scenario, the method further includes:
caching service data according to a cache policy corresponding to the second specific scenario.

In the foregoing design, the terminal device caches the service data according to the cache policy corresponding to the second specific scenario, so that smoothness of using the terminal device by a user in the second specific scenario can be improved, and the terminal device can provide a good communication service for the user as much as possible in the second specific scenario, to improve communication experience of using the terminal device by the user in the second specific scenario.

In a possible design, after the determining that the terminal device is in the second specific scenario, the method further includes:
determining, based on a cell handover path corresponding to the second specific scenario, that the terminal device is to perform handover to a second cell;
when determining, based on communication status records of the plurality of cells in the area corresponding to the second specific scenario, that the second cell is a cell whose communication quality is lower than a communication quality threshold, determining, from a plurality of cells adjacent to the first cell on which the terminal device currently camps, a third cell whose communication quality is higher than the communication quality threshold; and
performing handover to the third cell.

In the foregoing design, when identifying, based on the cell handover path corresponding to the second specific scenario and the communication status records of the plurality of cells in the area corresponding to the second specific scenario, that the terminal device is to perform handover to the second cell whose communication quality is lower than the communication quality threshold, the terminal device may accurately determine in time, from the plurality of cells adjacent to the first cell, the third cell whose communication quality is higher than the communication quality threshold. In this way, in this solution, it can be ensured that the terminal device can camp on a cell with high communication quality, so that the terminal device can provide a good communication service for the user as much as possible in the second specific scenario, to help improve communication experience of using the terminal device by the user in the second specific scenario.

In a possible design, after the determining that the terminal device is in the second specific scenario, the method further includes:
after the terminal device performs handover from the first cell to a fourth cell, obtaining cell information of the fourth cell;
when the second cellular cell set does not include the cell information of the fourth cell or the cell information of the fourth cell is not obtained, starting a timer, where the timer is used to count second duration in which the terminal device is not identified as being in the second specific scenario; and
when the second duration is greater than a second duration threshold, determining that the terminal device leaves the second specific scenario.

In the foregoing design, when determining that the second cellular cell set does not include the cell information of the fourth cell on which the terminal device currently camps or the cell information of the fourth cell on which the terminal device currently camps is not obtained, the terminal device may start the timer to start timing, so that second duration in which the terminal device is not identified in a specific scenario can be accurately counted, and effective support can be provided for accurately identifying whether the terminal device leaves the specific scenario.

In a possible design, the method further includes:
when the terminal device performs handover from the fourth cell to a fifth cell, if the second cellular cell set includes cell information of the fifth cell, stopping timing of the timer; or if the second cellular cell set does not include cell information of the fifth cell or the cell information of the fifth cell is not obtained, continuing timing of the timer.

In the foregoing design, when it is identified that the terminal device performs handover from the fourth cell to the fifth cell, and the second cellular cell set includes the cell information of the fifth cell, timing of the timer is stopped, and the terminal device is still in the second specific scenario. When it is identified that the terminal device performs handover from the fourth cell to the fifth cell, and the second cellular cell set does not include the cell information of the fifth cell or the cell information of the fifth cell is not obtained, timing of the timer continues. In this way, whether the terminal device leaves a specific scenario can be accurately determined based on duration counted by the timer.

In a possible design, the second cellular cell set is generated by the server based on the cell information of the plurality of cells in the area corresponding to the second specific scenario, and the plurality of cells in the area corresponding to the second specific scenario are determined by the server based on the first cellular cell set and a cell handover path reported by at least one terminal device after it is determined that the at least one terminal device is in the second specific scenario.

In the foregoing design, the server may summarize cell information of plurality of cells in an area corresponding to a specific scenario (for example, the second specific scenario) reported by each terminal device, to generate a cellular cell set corresponding to the second specific scenario. The cellular cell set corresponding to the second specific scenario may be used by any terminal device to accurately identify in time whether the terminal device is in the second specific scenario.

In a possible design, both the first specific scenario and the second specific scenario are subway scenarios, and the first area is a subway station area.

According to a second aspect, an embodiment of this application provides a terminal device. For beneficial effect, refer to descriptions of the first aspect. Details are not described herein again. The terminal device has a function of implementing behavior in the method instance in the first aspect. The function may be implemented by hardware, or may be implemented by hardware executing corresponding software. The hardware or the software includes one or more modules corresponding to the foregoing function. In a possible design, the terminal device includes a transceiver module and a processing module. The transceiver module is configured to receive, from a server, a first cellular cell set corresponding to a first specific scenario. The first specific scenario includes n first areas, n is an integer greater than or equal to 2, and the first cellular cell set includes cell information of a plurality of cells in each of the n first areas. The processing module is configured to: when identifying, based on cell information of a plurality of cells on which the terminal device camps, that the terminal device continuously passes through m first areas, determine that the terminal device is in the first specific scenario, where m is an integer greater than or equal to 2. The processing module is further configured to control the transceiver module to report, to the server, cell information of a plurality of cells on which the terminal device camps after determining that the terminal device is in the first specific scenario. These modules may perform corresponding functions in the method example in the first aspect. For details, refer to the detailed descriptions in the method example. Details are not described herein again.

According to a third aspect, an embodiment of this application provides a terminal device. The terminal device includes a transceiver and a processor, and optionally, further includes a memory. The memory is configured to store a computer program or instructions. The processor is coupled to the memory and the transceiver. When the processor executes the computer program or the instructions, the terminal device performs the method in any possible design of the first aspect.

According to a fourth aspect, an embodiment of this application provides a computer program product. The computer program product includes a computer program or instructions. When the computer program or the instructions are run on a computer, the computer is enabled to perform the method in any possible design of the first aspect.

According to a fifth aspect, an embodiment of this application provides a computer-readable storage medium. The computer-readable storage medium stores a computer program or instructions. When the computer program or the instructions are run on a computer, the computer is enabled to perform the method in any possible design of the first aspect.

According to a sixth aspect, an embodiment of this application further provides a chip. The chip is coupled to a memory, and the chip is configured to read a computer program stored in the memory, to perform the method in any possible design of the first aspect.

According to a seventh aspect, an embodiment of this application further provides a chip system. The chip system includes a processor, configured to support a computer apparatus in implementing the method in any possible design of the first aspect. In a possible design, the chip system further includes a memory, and the memory is configured to store a program and data that are necessary for the computer apparatus. The chip system may include a chip, or may include a chip and another discrete component.

### BRIEF DESCRIPTION OF DRAWINGS

FIG. 1 is an example of a diagram of an application scenario according to an embodiment of this application;

FIG. 2 is an example of a diagram of a structure of a terminal device according to an embodiment of this application;

FIG. 3 is an example of a diagram of a structure of function modules of a terminal device according to an embodiment of this application;

FIG. 4 is an example of a diagram of a structure of a server according to an embodiment of this application;

FIG. 5 is an example of a schematic flowchart of a data processing method according to an embodiment of this application;

FIG. 6 is an example of a schematic flowchart of a method for determining a second cellular cell set according to an embodiment of this application;

FIG. 7 is an example of a diagram of generating a second cellular cell set corresponding to a subway scenario according to an embodiment of this application;

FIG. 8 is an example of a schematic flowchart of a specific scenario identification method according to an embodiment of this application;

FIG. 9 is an example of a diagram in which a terminal device passes through a plurality of cellular cells in a subway scenario according to an embodiment of this application;

FIG. 10 is an example of another diagram in which a terminal device passes through a plurality of cellular cells in a subway scenario according to an embodiment of this application;

FIG. 11 is an example of a diagram of a structure of a possible terminal device according to an embodiment of this application; and

FIG. 12 is an example of a diagram of a structure of a possible terminal device according to an embodiment of this application.

### DESCRIPTION OF EMBODIMENTS

Before technical solutions provided in this application are described, some terms in this application are first explained and described, to facilitate understanding by a person skilled in the art.

(1) A terminal device, also referred to as a terminal, is an entity that is on a user side and that has a signal receiving and sending function, and may provide a service function like video, voice, and data connectivity for a user.

For example, the terminal device may be a mobile phone, a tablet computer, a computer (like a notebook computer) with a wireless transceiver function, a wearable device (like a smartwatch, a smart band, smart glasses, or a smart helmet) with a wireless communication function, a virtual reality device, or the like. For example, the terminal device may alternatively include a mobile phone (or referred to as a “cellular” phone), a computer with a mobile terminal device, or a portable, pocket-sized, handheld, computer built-in mobile apparatus, or the like. For example, it may be a device like a personal communication service (PCS) phone, a cordless telephone set, a session initiation protocol (SIP) phone, a wireless local loop (WLL) station, or a personal digital assistant (PDA).

Optionally, the terminal device alternatively includes a limited device, for example, a device with low power consumption, a device with a limited storage capability, or a device with a limited computing capability. For example, the terminal device includes an information sensing device like a barcode, radio frequency identification (RFID), a sensor, a global positioning system (GPS), or a laser scanner.

(2) A network device is an entity that is on a network side and that has a signal receiving and sending function.

For example, the network device may be configured to perform mutual conversion between a received over-the-air frame and a network protocol packet, and may be used as a router between a terminal device and a remaining part of an access network.

Certainly, the network device may further coordinate attribute management of an air interface. For example, the network device may be referred to as a base station, may cover one or more cells, and may be a device that communicates with a wireless terminal device over an air interface in an access network through one or more cells. For example, the network device may be a next-generation NodeB (gNB) (5G base station) in a 5G communication system, an evolved NodeB (eNB) (4G base station) in a 4G communication system, a radio network controller (RNC), a new radio controller (NR controller), a base station controller (BSC), a home base station (like a home evolved NodeB or a home NodeB, HNB), a baseband unit (BBU), a wireless fidelity (Wi-Fi) access point (AP), a roadside unit (RSU), a base transceiver station (BTS), a central unit (CU), or the like.

(3) A server has information processing and information forwarding functions, and is a device that can provide a data connectivity service. In addition, the server may respond to a service request of a terminal device and process the service request. Therefore, usually, the server needs to have capabilities of bearing a service and assuring the service.

In this application, the server may be a server located in a data network (DN), for example, a common server or a server on a cloud platform; or a multi-access edge computing (MEC) server located in a core network.

In addition, it should be understood that the terms “first”, “second”, and the like in embodiments, the claims, and the accompanying drawings of this application are intended to distinguish between similar objects but do not necessarily indicate a specific order or sequence. In addition, the terms “include”, “have”, and any variant thereof are intended to cover non-exclusive inclusion, for example, include a series of steps or units. Methods, systems, products, or devices are not necessarily limited to those steps or units that are literally enumerated, but may include other steps or units that are not literally enumerated or that are inherent to such processes, methods, products, or devices.

The following describes embodiments of this application in detail with reference to the accompanying drawings.

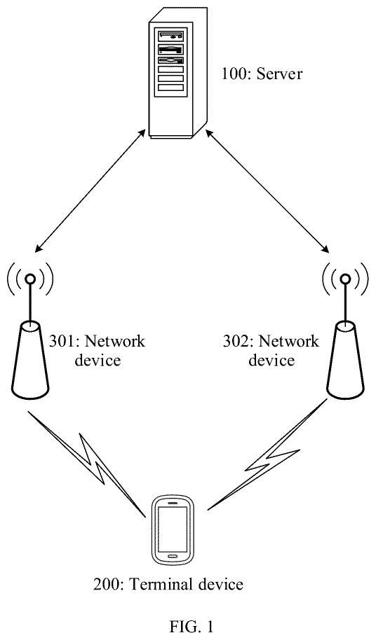

FIG. 1 is an example of a diagram of an application scenario according to an embodiment of this application. At least one network device (for example, a network device 301 and a network device 302), a server 100 connected to the at least one network device, and a terminal device 200 handheld by a user are included in the application scenario.

Optionally, the server 100 may collect cellular cell information of a plurality of cellular cells reported by one or more terminal devices 200, and generate, based on location information of a plurality of first areas included in an area corresponding to a specific scenario (for example, a subway scenario, a tunnel scenario, or a mining scenario) and the cellular cell information of the plurality of cellular cells, a second cellular cell set corresponding to the specific scenario. Then, the server 100 may deliver the second cellular cell set corresponding to the specific scenario to the terminal device 200.

Optionally, the server may alternatively collect cellular cell information of a plurality of cellular cells that is reported when one or more terminal devices 200 camp on an area corresponding to a specific scenario, and generate, based on location information of a plurality of first areas included in the area corresponding to the specific scenario and the cellular cell information of the plurality of cellular cells, a second cellular cell set corresponding to the specific scenario. Then, the server 100 may deliver the second cellular cell set corresponding to the specific scenario to the terminal device 200. In this way, when the terminal device 200 camps on an area corresponding to a specific scenario, whether the terminal device 200 is in the specific scenario may be quickly and accurately identified based on a second cellular cell set corresponding to the specific scenario. Then, after determining that the terminal device 200 is in the specific scenario, the terminal device 200 may perform a corresponding operation or perform a corresponding configuration, to ensure communication performance of the terminal device 200, and ensure user experience.

The cellular cell information may include but is not limited to a cell identifier of a cellular cell, location information of the terminal device in a cellular cell on which the terminal device camps, a signal status of the cellular cell, and the like. Optionally, when the terminal device camps on a cellular cell, the terminal device may learn of a cell identifier of the cellular cell on which the terminal device camps, and may obtain longitude and latitude coordinates of the terminal device through a positioning module. For example, the positioning module implements positioning of the terminal device through a GPS. A GPS positioning manner may include pseudo-range measurement, carrier phase measurement, Doppler measurement, and the like. The longitude and latitude coordinates of the terminal device may be used as location information of the terminal device in the cellular cell. Then, the terminal device may report, to the server, the location information of the terminal device in the cellular cell on which the terminal device camps and the cell identifier of the cellular cell on which the terminal device camps. Certainly, the location information of the terminal device in the cellular cell on which the terminal device camps may also be determined in another positioning manner (for example, AOA (Angle of Arrival, angle of arrival positioning) or TOA (Time of Arrival, time of arrival positioning)). This is not limited in embodiments of this application.

A second cellular cell set corresponding to any specific scenario includes cellular cell information of one or more cells located in an area corresponding to the specific scenario.

Optionally, the server 100 may deliver, at specific time, in a specific cycle, or periodically, an updated second cellular cell set corresponding to one or more specific scenarios to the terminal device 200. Alternatively, the terminal device 200 may request, at specific time, in a specific cycle, or periodically from the server 100, a latest second cellular cell set corresponding to one or more specific scenarios. This is not limited in this application.

For example, the specific scenario is a subway scenario. A subway station that the user passes through by taking a subway and an area that the subway passes by are areas corresponding to the specific scenario. In the subway scenario, a process in which the terminal device 200 identifies the subway scenario is described as follows:

For example, when a user carries a terminal device 200 and enters a subway station (for example, a subway station A) to take a subway, the terminal device 200 may automatically collect cellular cell information of a cellular cell on which the terminal device camps, and match the cellular cell information of the cellular cell on which the terminal device camps with a second cellular cell set that corresponds to the subway scenario and that is obtained from the server 100 (namely, a cellular cell set that is selected by the server and used to identify whether the terminal device is in the subway scenario), to determine whether the cellular cell on which the terminal device camps is a cellular cell in the subway scenario. Optionally, the second cellular cell set that corresponds to the subway scenario and that is selected by the server may include each cellular cell that belongs to an in-station part of each subway station, or may include each cellular cell that belongs to an in-station part of each subway station and each cellular cell deployed on a subway track between any neighboring subway stations. This is not limited in embodiments of this application. Optionally, the server may alternatively select each cellular cell that belongs to an out-of-station part of each subway station, and may mark each cellular cell that belongs to the out-of-station part of each subway station as a cellular cell outside the subway station.

Optionally, the second cellular cell set corresponding to the subway scenario is obtained by the terminal device 200 by sending a data obtaining request to the server 100 in a specific cycle. For example, the terminal device 200 may send the data obtaining request to the server 100 at a specified time interval (for example, every one day, every three days, every five days, every seven days, every ten days, or every more than ten days), so that a latest second cellular cell set corresponding to the subway scenario can be obtained from the server 100 in time.

Optionally, the second cellular cell set corresponding to the subway scenario is generated by the server 100 by summarizing collected cellular cell information of each cellular cell, subway station location information, and a cellular cell handover record that are reported by each terminal device 200.

After receiving a latest second cellular cell set corresponding to the subway scenario from the server 100, the terminal device 200 may use the latest second cellular cell set corresponding to the subway scenario to cover a locally stored historical second cellular cell set corresponding to the subway scenario, or may first delete the locally stored historical second cellular cell set corresponding to the subway scenario, and then locally store the newly obtained second cellular cell set corresponding to the subway scenario.

For example, refer to FIG. 1. When the network device 301 is deployed on a ground part (which is not located in an area corresponding to a specific scenario, and does not belong to the subway scenario) of an area in which the subway station A is located, and the network device 302 is deployed on an underground part (which is located in the area corresponding to the specific scenario, and belongs to the subway scenario), the terminal device 200 may sequentially communicate with the network device 301 and the network device 302. In this way, the terminal device 200 may collect cellular cell information belonging to a cellular cell that is managed by the network device 301 and on which the terminal device 200 camps, and match the cellular cell information belonging to the cellular cell that is managed by the network device 301 with the second cellular cell set corresponding to the subway scenario, to determine whether the cellular cell on which the terminal device 200 camps is a cellular cell in the subway scenario. However, because the cellular cell managed by the network device 301 is a cellular cell that belongs to an out-of-station part of the subway station A, matching fails, and it may be determined that the terminal device 200 is not currently in the subway scenario.

After the terminal device 200 enters the subway station A, the terminal device 200 may collect cellular cell information belonging to a cellular cell that is managed by the network device 302 and on which the terminal device 200 camps, and match the cellular cell information belonging to the cellular cell that is managed by the network device 302 with the second cellular cell set corresponding to the subway scenario, to determine whether the cellular cell on which the terminal device 200 camps is a cellular cell in the subway scenario. If the terminal device 200 determines that the cellular cell on which the terminal device camps is a cellular cell in the subway scenario, the terminal device 200 may determine that the terminal device is in the subway scenario. Then, the terminal device 200 may optimize communication experience in the subway scenario for the terminal device 200. For example, the terminal device 200 may notify, in advance, one or more applications installed on the terminal device 200 of a condition in which the terminal device 200 is in the subway scenario, so that the one or more applications can adjust respective cache policies of the one or more applications in advance. In this way, a process of using an application by a user in the subway scenario is smooth, and no freezing occurs.

It should be noted that FIG. 1 merely provides an example of an application scenario, and does not constitute a limitation on an application scenario of the method provided in this application. This application is applicable to various application scenarios in which a cellular cell is in a non-open environment.

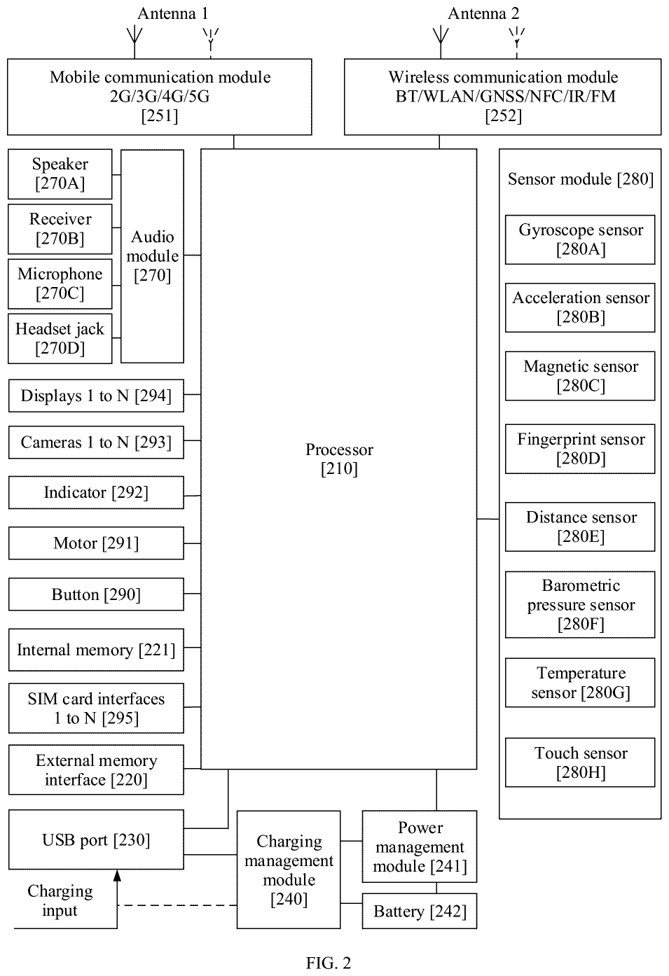

Based on the application scenario shown in FIG. 1, an embodiment of this application provides a terminal device. Refer to FIG. 2. The terminal device may include a processor 210, an external memory interface 220, an internal memory 221, a universal serial bus (USB) port 230, a charging management module 240, a power management module 241, a battery 242, an antenna 1, an antenna 2, a mobile communication module 251, a wireless communication module 252, an audio module 270, a speaker 270A, a receiver 270B, a microphone 270C, a headset jack 270D, a sensor module 280, a button 290, a motor 291, an indicator 292, a camera 293, a display 294, a subscriber identification module (SIM) card interface 295, and the like.

The sensor module 280 may include a gyroscope sensor 280A, an acceleration sensor 280B, a magnetic sensor 280C, a fingerprint sensor 280D, a distance sensor 280E, a barometric pressure sensor 280F, a temperature sensor 280G, and a touch sensor 280H. Certainly, the terminal device may further include another sensor, for example, a pressure sensor, an ambient light sensor, or a bone conduction sensor. It should be noted that the antenna 1 and the antenna 2 shown in FIG. 2 are examples, and another antenna may alternatively be included in some other embodiments. It should be understood that the terminal device shown in FIG. 2 is merely an example, and does not constitute a limitation on the terminal device. For example, the terminal device may have more or fewer components than those shown in FIG. 2, may combine some components, or may have different component arrangements.

The following describes some components of the terminal device in detail with reference to FIG. 2.

The processor 210 in FIG. 2 may include one or more processing units. For example, the processor 210 may include an application processor (AP), a baseband processor, a graphics processing unit (GPU), an image signal processor (ISP), a controller, a memory, a video codec, a digital signal processor (DSP), a neural-network processing unit (NPU), and/or the like. Different processing units may be independent devices, or may be integrated into one or more processors. The controller may be a nerve center and a command center of the terminal device. The controller may generate an operation control signal based on an instruction operation code and a time sequence signal, to complete control of instruction reading and instruction execution. For example, the processor 210 may access a communication system (including an access network and a core network) through the mobile communication module 251 or the wireless communication module 252, and connect to a server through the communication system, to receive a second cellular cell set corresponding to one or more specific scenarios sent by the server, receive a first cellular cell set corresponding to one or more specific scenarios sent by the server, or the like.

In some embodiments, a memory may further be disposed in the processor 210, to store instructions and data. For example, the memory in the processor 210 may be a cache memory. The memory may store instructions or data just used or cyclically used by the processor 210. If the processor 210 needs to use the instructions or the data again, the processor 210 may directly invoke the instructions or the data from the memory. This avoids repeated access and reduce waiting time of the processor 210, thereby improving system efficiency.

The external memory interface 220 may be configured to connect to an external memory card, for example, a micro SD card, to extend a storage capability of the terminal device. The external memory card communicates with the processor 210 through the external memory interface 220, to implement a data storage function. For example, files such as pictures or videos may be stored in the external memory card.

The internal memory 221 may be configured to store computer-executable program code, and the executable program code includes instructions. The internal memory 221 may include a program storage area and a data storage area. The program storage area may store an operating system, an application required by at least one function (for example, a voice playing function or an image playing function), and the like. The data storage area may store data (for example, audio data or a phone book) created in a process of using the terminal device. In addition, the internal memory 221 may include a high-speed random access memory, and may further include a non-volatile memory, for example, at least one magnetic disk storage device, a flash memory device, or a universal flash storage (UFS). The processor 210 performs various function applications and data processing of the terminal device by running the instructions stored in the internal memory 221 and/or the instructions stored in the memory disposed in the processor.

The universal serial bus port 230 is an interface that conforms to a USB standard specification, and may be specifically a mini USB port, a micro USB port, a USB type-C port, or the like. The USB port 230 may be used to connect to a charger to charge the terminal device, or may be used to transmit data between the terminal device and a peripheral device. The charging management module 240 is configured to receive a charging input from the charger. The power management module 241 is configured to connect to the battery 242, the charging management module 240, and the processor 210. The power management module 241 receives an input from the battery 242 and/or the charging management module 240, and supplies power to the processor 210, the internal memory 221, an external memory, the display 294, the camera 293, the wireless communication module 252, and the like.

A wireless communication function of the terminal device may be implemented by using the antenna 1, the antenna 2, the mobile communication module 251, the wireless communication module 252, a modem processor, the baseband processor, and the like. The terminal device may obtain longitude and latitude coordinates of a location of the terminal device based on the wireless communication function of the terminal device, and may obtain location information of a network device that communicates with the terminal device in an area in which the terminal device is located and device information (for example, a device identifier number) of the network device. Certainly, the terminal device may further obtain a signal strength status of a cellular cell communicating with the terminal device.

The mobile communication module 251 may provide a wireless communication solution that includes 2G/3G/4G/5G or the like and that is applied to the terminal device. The mobile communication module 251 may include at least one filter, a switch, a power amplifier, a low noise amplifier (LNA), and the like. The mobile communication module 251 may receive an electromagnetic wave through the antenna 1, perform processing such as filtering or amplification on the received electromagnetic wave, and transmit the electromagnetic wave to the baseband processor for demodulation. The mobile communication module 251 may further amplify a signal modulated by the baseband processor, and convert the signal into an electromagnetic wave for radiation through the antenna 1. In some embodiments, at least some function modules in the mobile communication module 251 may be disposed in the processor 210. In some embodiments, at least some function modules of the mobile communication module 251 may be disposed in a same device as at least some modules of the processor 210.

The wireless communication module 252 may provide a wireless communication solution that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like and that is applied to the terminal device. The wireless communication module 252 may be one or more components integrating at least one communication processor module. The wireless communication module 252 receives an electromagnetic wave through the antenna 2, performs frequency modulation and filtering processing on an electromagnetic wave signal, and sends a processed signal to the processor 210. The wireless communication module 252 may further receive a to-be-sent signal from the processor 210, perform frequency modulation and amplification on the signal, and convert the signal into an electromagnetic wave for radiation through the antenna 2.

The gyroscope sensor 280A may be configured to determine a posture of the terminal device. In some embodiments, angular velocities of the terminal device around three axes (namely, x, y, and z axes) may be determined by using the gyroscope sensor 280A. The acceleration sensor 280B may be configured to detect values of accelerations of the terminal device in various directions (generally on three axes, for example, an x axis, a y axis, and a z axis).

The magnetic sensor 280C is a device that converts a magnetic energy change of a sensitive element caused by an external factor like a magnetic field, a current, a stress strain, a temperature, or light into an electrical signal, and detects a corresponding physical quantity in this manner, including a Hall effect sensor, an anisotropic magnetoresistance sensor, and the like. The magnetic sensor 280C may be configured to sense a speed, a movement, and a direction of the terminal device, and may be further configured to detect a magnetic field, measure a magnitude of an external magnetic field, and the like. The distance sensor 280E is configured to measure a distance. The terminal device may measure a distance by using infrared light or a laser. The barometric pressure sensor 280F may be configured to measure barometric pressure. In some embodiments, the terminal device calculates an altitude through the barometric pressure measured by the barometric pressure sensor 280F, to assist in positioning and navigation.

In some embodiments, the antenna 1 of the terminal device may be coupled to the mobile communication module 251, and the antenna 2 thereof may be coupled to the wireless communication module 252, so that the terminal device can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, the GNSS, the WLAN, the NFC, the FM, the IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

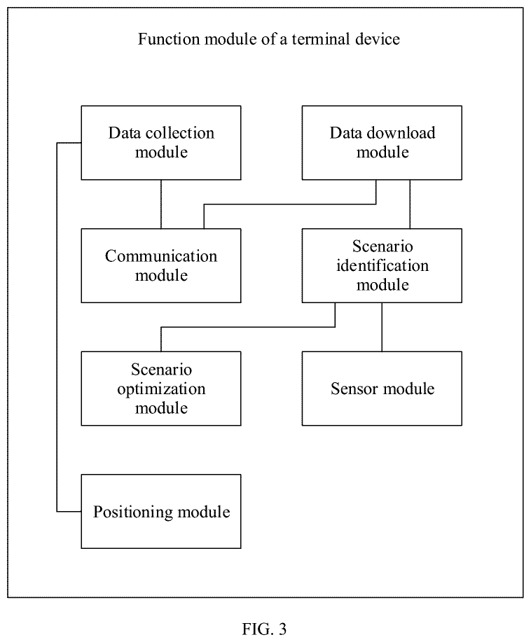

Based on the terminal device shown in FIG. 2, an embodiment of this application further provides a function module structure of the terminal device. Refer to FIG. 3. The following modules may be obtained through division based on logical functions of the terminal device: a data collection module, a data download module, a scenario identification module, a scenario optimization module, a positioning module, a communication module, a sensor module, and the like. It should be noted that a connection relationship between the modules shown in FIG. 3 is merely an example, and does not constitute a limitation on embodiments of this application. The following describes a function of each module.

The data collection module is configured to collect cellular cell data. Optionally, in a process in which a user to which the terminal device belongs is located in an area corresponding to a specific scenario, the data collection module may collect cellular cell information of a cellular cell on which the terminal device camps (for example, a cell identifier of the cellular cell on which the terminal device camps and location information of the terminal device in the cellular cell on which the terminal device camps), and report, through the communication module, the collected cellular cell information of the cellular cell to a server via a network device to which the terminal device accesses. Alternatively, the data collection module may report a cellular cell handover path generated by the terminal device to a server.

The data download module is configured to download information related to a cellular cell. For example, the data download module may query and download, in a specific cycle through the communication module from the server via the network device accessed by the terminal device, the information related to the cellular cell, for example, a first cellular cell set or a second cellular cell set corresponding to a specific scenario. Alternatively, the data download module may query and download, through the communication module from the server via the network device accessed by the terminal device, a cellular cell handover path generated in a process in which the user to which the terminal device belongs moves in an area corresponding to a specific scenario.

The scenario identification module is configured to identify whether the terminal device is in a specific scenario. For example, in a subway scenario, the scenario identification module may be configured to identify whether the terminal device is in the subway scenario. Alternatively, for example, in a tunnel scenario, the scenario identification module may be configured to identify whether the terminal device is in the tunnel scenario.

The scenario optimization module is configured to: when it is identified that the terminal device is in a specific scenario, identify whether there is a problematic cell in a moving path of the terminal device; if there is a problematic cell, choose to avoid the problematic cell, and select an optimal cellular cell handover path; and when it is identified that the terminal device is in a specific scenario, indicate an App installed on the terminal device to adjust a cache policy of the App.

The positioning module is configured to determine longitude and latitude coordinates of the terminal device. For example, the positioning module may implement positioning of the terminal device through a GPS, a BDS, or the like.

The communication module is configured to provide a communication service for the user, and provide cellular data for the data collection module. For example, the terminal device may complete the communication service through the mobile communication module 251, the wireless communication module 252, or the like.

The sensor module is configured to identify a movement status of the terminal device based on an acceleration, an electromagnetic feature, and the like, so that a motion status of the user can be sensed. For example, the sensor module may collect the acceleration, the electromagnetic feature, and the like of the terminal device through an acceleration sensor, a magnetic sensor, and the like, to determine the movement status (or may be referred to as a movement feature) of the terminal device based on the collected acceleration, the collected electromagnetic feature, and the like.

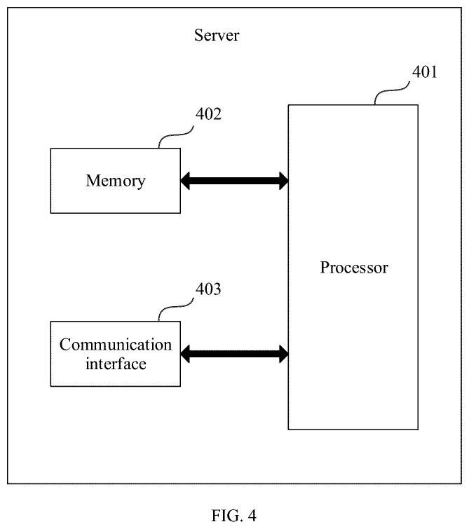

Based on the application scenario shown in FIG. 1, an embodiment of this application provides a server. Refer to FIG. 4. The server includes components such as a processor 401, a memory 402, and a communication interface 403. The processor 401 and another component are connected to each other.

The communication interface 403 is used to communicate with another device. The memory 402 may be configured to store computer-executable program code, and the executable program code includes instructions. The processor 401 executes various functions of the server by running the instructions stored in the memory 402. The memory 402 may include a program storage area and a data storage area. The program storage area may store an operating system of the server, a program for processing received cellular cell information reported by each terminal device, a cellular cell handover path, or the like, software code of at least one application, and the like. The data storage area may store cellular cell information that is reported by each terminal device and that is of a cellular cell on which each terminal device camps, a cellular cell handover path reported by each terminal device, a second cellular cell set corresponding to one or more specific scenarios, a first cellular cell set corresponding to one or more specific scenarios, or the like.

In addition, the memory 402 may include a high-speed random access memory, and may further include a non-volatile memory, for example, at least one magnetic disk storage device, a flash memory device, or a universal flash storage (UFS).

The processor 401 may include one or more processor units, for example, an application processor (AP), a controller, and a memory. Different processing units may be independent devices, or may be integrated into one or more processors. The controller may be a nerve center and a command center of the server, may generate an operation control signal based on instruction operation code and a time sequence signal, to complete control of instruction reading and instruction execution. For example, the processor 401 may be connected to a communication system (including a core network and an access network) through the communication interface 403, and further connected to a terminal device through the communication system, to send, to the terminal device, a second cellular cell set (or a first cellular cell set) corresponding to one or more specific scenarios.

A memory having a buffer function may be further disposed in the processor 401, and is configured to store instructions and data. In some embodiments, the memory in the processor 401 is a cache memory. The memory may store instructions or data just used or cyclically used by the processor 401. If the processor 401 needs to use the instructions or the data again, the processor 401 may directly invoke the instructions or the data from the memory therein. This avoids repeated access from the memory 402, reduces waiting time of the processor 401, and improves operating efficiency of the processor.

It should be noted that a structure of the server shown in FIG. 4 does not constitute a limitation on the server, and the server used in the application scenario shown in FIG. 1 may include more or fewer components than those shown in FIG. 4. For example, the server may further include an external memory interface that is configured to connect to an external memory, a display, and the like.

The following describes in detail a specific implementation of the data processing method in this application based on the application scenario shown in FIG. 1.

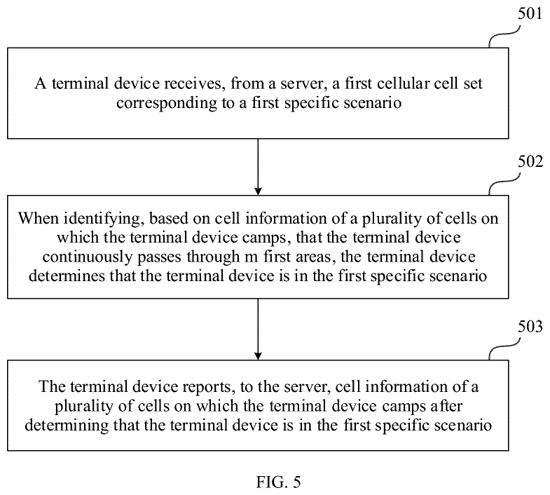

FIG. 5 is an example of a schematic flowchart of a data processing method according to an embodiment of this application. The method is applicable to a terminal device, for example, the terminal device 200 shown in FIG. 1. As shown in FIG. 5, a procedure of the method includes the following steps.

Step 501: The terminal device receives, from a server, a first cellular cell set corresponding to a first specific scenario.

In an example, the server may actively send the first cellular cell set corresponding to the first specific scenario in a specific cycle to one or more terminal devices. In another example, the server may alternatively send, based on a data obtaining request sent by one or more terminal devices, the first cellular cell set corresponding to the first specific scenario to the one or more terminal devices. Certainly, the server may alternatively send, in another manner, the first cellular cell set corresponding to the first specific scenario to one or more terminal devices. This is not limited in embodiments of this application.

Optionally, the first specific scenario may include n first areas, and n is an integer greater than or equal to 2. For example, the first areas may be subway station areas corresponding to a subway scenario, for example, a subway operation line corresponding to the subway scenario. The subway operation line may include a plurality of subway station areas. Alternatively, the first areas may be specific areas corresponding to a tunnel scenario. For example, a plurality of specific areas (for example, a refuge recess area or a fire fighting facility area) may be disposed in a tunnel area corresponding to the tunnel scenario. Alternatively, the first areas may be specific areas corresponding to a mining scenario, and so on. For example, a plurality of specific areas (for example, a mining vehicle parking area or a mining tool storage area) may be disposed in a mining area corresponding to the mining scenario. This is not limited in embodiments of this application.

Optionally, the first cellular cell set may include cell information of a plurality of cells in each of the n first areas. For example, cell information of any cell may include but is not limited to a cell identifier of the cell, location information of the terminal device in the cell, a signal feature of the cell (for example, a communication status of the cell), or the like.

For example, a specific scenario is a subway scenario. A first cellular cell set corresponding to the subway scenario may include cell information of a plurality of cells in each subway station area of a plurality of subway station areas. Alternatively, a specific scenario is a tunnel scenario. A first cellular cell set corresponding to the tunnel scenario may include cell information of a plurality of cells in each refuge recess area of a plurality of specific areas (for example, refuge recess areas).

Optionally, after receiving the cell information that is of the one or more cells on which the terminal device camps and that is reported by each of the plurality of terminal devices, the server may summarize cell information that is of a plurality of cells and that is reported by the plurality of terminal devices, to obtain cell identifiers of the plurality of cells and longitude and latitude ranges of the plurality of cells. For example, for a cell identifier of a same cell, the server may determine, based on location information of a plurality of terminal devices camping on the cell, longitude and latitude ranges of the cell. Then, the server may store the cell identifiers of the plurality of cells and the longitude and latitude ranges of the plurality of cells into a cell location database. Then, the server may generate, based on the cell location database, a first cellular cell set corresponding to a specific scenario (for example, the first specific scenario).

For example, the specific scenario is a subway scenario. The server may obtain longitude and latitude ranges of subway station areas, and may sequentially match longitude and latitude ranges of any subway station area with longitude and latitude ranges of each cell in the cell location database, to obtain at least one cellular cell of the subway station area through matching, and summarize cellular cell information of cellular cells of the subway station areas, to obtain a first cellular cell set corresponding to the subway scenario.

For another example, the specific scenario is a tunnel scenario. The server may obtain longitude and latitude ranges of specific areas (for example, refuge recess areas) corresponding to the tunnel scenario, and may sequentially match longitude and latitude ranges of any refuge recess area with longitude and latitude ranges of each cell in the cell location database, to obtain at least one cellular cell of the refuge recess area through matching, and summarize cellular cell information of cellular cells in the refuge recess areas, to obtain a first cellular cell set corresponding to the tunnel scenario.

For another example, the specific scenario is a mining scenario. The server may obtain longitude and latitude ranges of specific areas (for example, mining vehicle parking areas) corresponding to the mining scenario, and may sequentially match longitude and latitude ranges of any mining vehicle parking area with longitude and latitude ranges of each cell in the cell location database, to obtain at least one cellular cell of the mining vehicle parking area through matching, and summarize cellular cell information of cellular cells in the mining vehicle parking areas, to obtain a first cellular cell set corresponding to the mining scenario.

Step 502: When identifying, based on cell information of a plurality of cells on which the terminal device camps, that the terminal device continuously passes through m first areas, the terminal device determines that the terminal device is in the first specific scenario.

Optionally, the first cellular cell set corresponding to the first specific scenario includes identifier numbers (or numbers, or sequence numbers, or names, or the like) of a plurality of first areas and cell information of a plurality of cells in each of the plurality of first areas. Therefore, the terminal device sequentially matches cell information of each cell of the plurality of cells on which the terminal device camps with cell information of each cell in the first cellular cell set, to determine a first area in which the cell on which the terminal device camps is located, and further determine whether the terminal device continuously passes through the m first areas. When determining that the terminal device continuously passes through the m first areas, the terminal device may determine that the terminal device is in the first specific scenario. Herein, m may be an integer value of 2 or more, and may be specifically set based on experience of a person skilled in the art or an actual application scenario. This is not limited in embodiments of this application.

For example, the specific scenario is a tunnel scenario. It is assumed that the terminal device camps on five cells: a cell 1, a cell 2, a cell 3, a cell 4, and a cell 5, and it is assumed that five refuge recess areas, which are a refuge recess area a1, a refuge recess area a2, a refuge recess area a3, a refuge recess area a4, and a refuge recess area a5, are disposed in a tunnel area corresponding to the tunnel scenario. Each time the terminal device camps on a cell, the terminal device may sequentially match cell information of the cell with cell information of each cell in the first cellular cell set, to determine a refuge recess area in which the cell on which the terminal device camps is located. For example, it is assumed that the terminal device determines that the cell 1 and the cell 2 are located in the refuge recess area a1, and the cell 3, the cell 4, and the cell 5 are located in the refuge recess area a2. In this case, it may be determined that the terminal device continuously passes through two refuge recess areas, and it may be determined that the terminal device is in the tunnel scenario.

Optionally, to more accurately determine whether the terminal device is in the first specific scenario, the terminal device may alternatively perform comprehensive determining based on the cell information of the plurality of cells on which the terminal device camps and with reference to a movement feature of the terminal device.

For example, when determining, based on the cell information of the plurality of cells on which the terminal device camps, that the terminal device continuously passes through the m subway station areas, and determining that the movement feature of the terminal device matches a movement feature of the terminal device in the first specific scenario, the terminal device may more accurately determine that the terminal device is in the first specific scenario.

Step 503: The terminal device reports, to the server, cell information of a plurality of cells on which the terminal device camps after determining that the terminal device is in the first specific scenario.

Optionally, after determining that the terminal device is in a specific scenario (for example, the first specific scenario), the terminal device may report, to the server, the cell information of the plurality of cells on which the terminal device camps after the terminal device is in the first specific scenario. After receiving cell information that is reported by each of the plurality of terminal devices and that is of a plurality of cells on which the terminal device camps after the terminal device is in the first specific scenario, the server may summarize and store cell information of a plurality of cells on which the plurality of terminal devices camp after the plurality of terminal devices are in the first specific scenario.

Optionally, the server may further obtain a cell handover path that is generated by performing cell handover after the terminal device is in the first specific scenario and that is reported by each of the plurality of terminal devices. Then, the server may determine, based on the first cellular cell set corresponding to the first specific scenario and cell handover paths reported by the plurality of terminal devices after the multiple terminal devices are in the first specific scenario, a plurality of cells in an area corresponding to the first specific scenario. Then, the server may generate, based on cell information of the plurality of cells in the area corresponding to the first specific scenario, a second cellular cell set corresponding to the first specific scenario. In this way, the server may generate a second cellular cell set corresponding to each specific scenario (for example, the first specific scenario, the second specific scenario, or a third specific scenario).

For example, the first specific scenario is used as an example. The first specific scenario may be a subway scenario, a tunnel scenario, a mining scenario, or the like. For another example, the second specific scenario is used as an example. The second specific scenario may be a subway scenario, a tunnel scenario, a mining scenario, or the like. This is not limited in embodiments of this application.

In addition, after generating the second cellular cell set corresponding to each specific scenario, the server may send the second cellular cell set corresponding to each specific scenario to one or more terminal devices, so that any terminal device can accurately determine in time, based on a second cellular cell set corresponding to any specific scenario, whether the terminal device is in the specific scenario.

Optionally, the server may actively send the second cellular cell set corresponding to each specific scenario to one or more terminal devices in a specific cycle, or may send the second cellular cell set corresponding to each specific scenario to one or more terminal devices based on a second cellular cell set obtaining request sent by the one or more terminal devices, or may send the second cellular cell set corresponding to each specific scenario to one or more terminal devices in another manner. This is not limited in embodiments of this application.

For example, the second specific scenario is used as an example. The terminal device may determine, in the following manners, that the terminal device is in the second specific scenario:

Manner 1: The terminal device may directly determine, based on a second cellular cell set corresponding to the second specific scenario, whether the second cellular cell set corresponding to the second specific scenario includes cell information of a first cell on which the terminal device currently camps, to determine whether the terminal device is in the second specific scenario. When the second cellular cell set corresponding to the second specific scenario includes the cell information of the first cell, the terminal device may determine that the terminal device is in the second specific scenario. The second cellular cell set corresponding to the second specific scenario includes cell information of a plurality of cells in an area corresponding to the second specific scenario.

Manner 2: The terminal device may alternatively determine a current physical location of the terminal device. For example, the terminal device may determine current longitude and latitude coordinates of the terminal device by using a positioning module of the terminal device. Then, the terminal device identifies, with reference to the second cellular cell set corresponding to the second specific scenario and the current physical location of the terminal device, whether the terminal device is in the second specific scenario. When the second cellular cell set corresponding to the second specific scenario includes the cell information of the first cell, and the current physical location of the terminal device belongs to the area corresponding to the second specific scenario, the terminal device may determine that the terminal device is in the second specific scenario. In this way, in this manner, with reference to the second cellular cell set corresponding to the second specific scenario and the current physical location of the terminal device, accuracy of identifying the specific scenario by the terminal device may be further improved.

Manner 3: The terminal device may alternatively determine a current second movement feature of the terminal device. For example, the terminal device may identify the current second movement feature of the terminal device by using a sensor module of the terminal device. Then, the terminal device identifies, with reference to the second cellular cell set corresponding to the second specific scenario and the current second movement feature of the terminal device, whether the terminal device is in the second specific scenario. When the second cellular cell set corresponding to the second specific scenario includes cell information of a first cell, and the current second movement feature of the terminal device matches a movement feature of the terminal device in the second specific scenario, the terminal device may determine that the terminal device is in the second specific scenario. In this way, in this manner, with reference to the second cellular cell set corresponding to the second specific scenario and the current second movement feature of the terminal device, accuracy of identifying a specific scenario by the terminal device can be further improved, and a probability of misidentifying a specific scenario by the terminal device can be effectively reduced.

Manner 4: The terminal device may alternatively determine first duration in which the terminal device camps on a first cell. For example, when identifying that the terminal device camps on the first cell, the terminal device may start a timer to start timing, and when identifying that the terminal device performs handover from the first cell to another cell, the terminal device stops timing of the timer. For example, when identifying that the terminal device performs handover from the first cell to any cell that does not belong to a second cellular cell set corresponding to the second specific scenario, the terminal device stops timing of the timer. Then, the terminal device determines, with reference to the second cellular cell set corresponding to the second specific scenario and the first duration in which the terminal device camps on the first cell, whether the terminal device is in the second specific scenario. When the second cellular cell set corresponding to the second specific scenario includes cell information of the first cell, and the first duration in which the terminal device camps on the first cell is greater than a first duration threshold, the terminal device may determine that the terminal device is in the second specific scenario. In this way, in this manner, with reference to the second cellular cell set corresponding to the second specific scenario and duration in which the terminal device camps on the first cell, accuracy of identifying a specific scenario by the terminal device can be further improved, and misidentification of a specific scenario by the terminal device that is caused because the terminal device temporarily camps on a cellular cell in a cellular cell set can be avoided as much as possible.

Optionally, after determining that the terminal device is in the second specific scenario, the terminal device may cache service data according to a cache policy corresponding to the second specific scenario.

For example, after identifying that the terminal device is in the second specific scenario, the terminal device may send a notification message to an application (for example, an App) installed on the terminal device, so that the application on the terminal device can adjust a cache policy, to meet a use requirement of a user in the second specific scenario, and further improve use experience of the user in the second specific scenario.

Optionally, after determining that the terminal device is in the second specific scenario, the terminal device may determine, based on a cell handover path corresponding to the second specific scenario, that the terminal device is to perform handover to a second cell. In addition, when determining, based on communication status records of the plurality of cells in the area corresponding to the second specific scenario, that the second cell is a cell whose communication quality is lower than a communication quality threshold, the terminal device may determine, from a plurality of cells adjacent to the first cell on which the terminal device currently camps, a third cell whose communication quality is higher than the communication quality threshold. Then, the terminal device may perform handover from the first cell to the third cell.

Optionally, a communication status record of any cell includes signal strength of the cell, a congestion condition of the cell, whether cell handover is normal, whether cell reestablishment exists, whether cell reselection is normal, and the like.

For example, it is assumed that a terminal device identifies that the terminal device is in the second specific scenario, and it is assumed that the terminal device currently camps on a cell a, the cell a has three neighboring cells: a cell b, a cell c, and a cell d, and the three neighboring cells are in a handover path direction in which the terminal device performs handover from the cell a. The terminal device determines, based on the cell handover path corresponding to the second specific scenario, that the terminal device is to perform handover to the cell b. In addition, the terminal device determines, based on the communication status records of the plurality of cells in the area corresponding to the second specific scenario, that the cell b is a cell whose communication quality is lower than the communication quality threshold. Then, to ensure that the terminal device can maintain a good communication signal in the second specific scenario, and can provide a good communication service for the user in the second specific scenario, the terminal device may determine, from the three neighboring cells of the cell a, a cell (for example, the cell c) whose communication quality is higher than the communication quality threshold as a cell to which the terminal device needs to perform handover. Then, the terminal device may perform handover from the cell a to the cell c.

Optionally, after determining that the terminal device is in the second specific scenario, if the terminal device identifies that the terminal device performs handover from the first cell to a fourth cell, the terminal device may obtain cell information of the fourth cell. When the cell information of the fourth cell is obtained and the second cellular cell set corresponding to the second specific scenario does not include the cell information of the fourth cell, or the cell information of the fourth cell is not obtained, the terminal device may start the timer to start timing. The timer is configured to collect statistics about second duration in which it is not identified that the terminal device is in the second specific scenario. Then, when the second duration is greater than a second duration threshold, the terminal device may determine that the terminal device leaves the second specific scenario.

For example, it is assumed that a terminal device identifies that the terminal device is in the second specific scenario, and it is assumed that the terminal device currently camps on a cell a. After identifying that the terminal device performs handover from the cell a to a cell b, the terminal device may obtain cell information of the cell b. If the cell information of the cell b may be obtained and the second cellular cell set corresponding to the second specific scenario does not include the cell information of the cell b, or the cell information of the cell b is not obtained, the terminal device may start the timer to start timing, where the timer is used to collect statistics about duration in which the terminal device is not in the second specific scenario. If the duration in which the terminal device is not in the second specific scenario is greater than the second duration threshold, the terminal device may determine that the terminal device leaves the second specific scenario. Optionally, the timer may also be configured to collect statistics about duration in which the terminal device is in the second specific scenario in the cell handover process. If the duration of being in the second specific scenario is less than a third duration threshold, the terminal device may determine that the terminal device leaves the second specific scenario.

Optionally, after the terminal device performs handover from the first cell to the fourth cell and starts the timer to start timing, if the terminal device identifies that the terminal device performs handover from the fourth cell to a fifth cell, the terminal device may stop timing of the timer when determining that the second cellular cell set corresponding to the second specific scenario includes cell information of the fifth cell. When determining that the second cellular cell set corresponding to the second specific scenario does not include the cell information of the fifth cell or the cell information of the fifth cell is not obtained, the terminal device may continue timing of the timer.

For example, after the terminal device performs handover from the first cell to the fourth cell and starts the timer to start timing, if the terminal device identifies that the terminal device performs handover from the cell b to a cell c, the terminal device may obtain cell information of the cell c. When the terminal device obtains the cell information of the cell c and the second cellular cell set corresponding to the second specific scenario includes the cell information of the cell c, the terminal device may stop timing of the timer. When the terminal device obtains the cell information of the cell c and the second cellular cell set corresponding to the second specific scenario does not include the cell information of the cell c, or the cell information of the cell c is not obtained, the terminal device may continue timing of the timer.

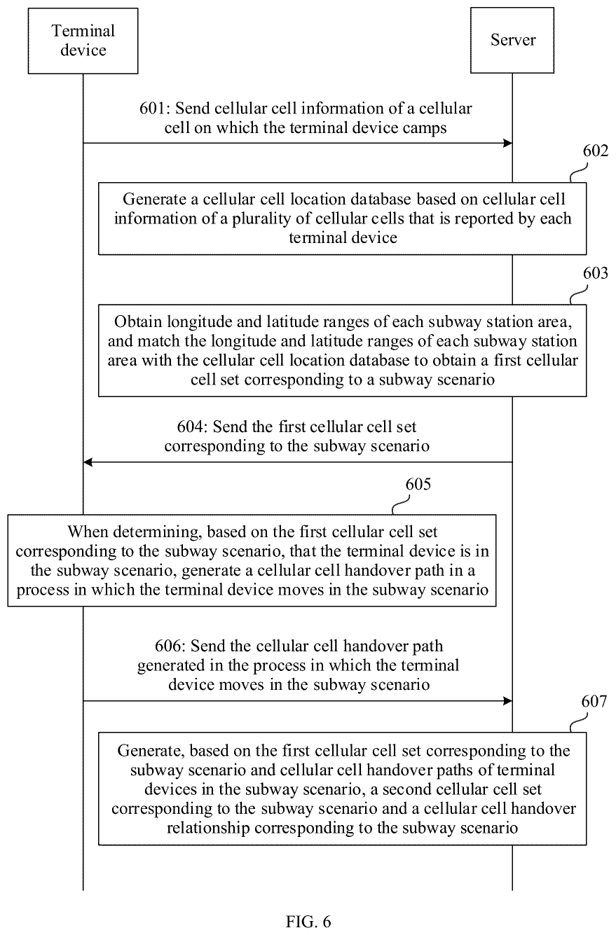

The following describes a method for determining a second cellular cell set according to an embodiment of this application by using an example in which a specific scenario is a subway scenario. The method is applicable to the application scenario shown in FIG. 1. Refer to FIG. 6. A procedure of the method includes the following steps.

Step 601: A terminal device sends, to a server, cellular cell information of a cellular cell on which the terminal device camps.

Optionally, in a process in which the terminal device is in a power-on communication state or a use state, the terminal device may report, to the server through a corresponding network device (for example, a base station), cellular cell information (for example, a cell identifier, including a PLMN (Public Land Mobile Network), a TAC (Tracking Area Code, indicating a mobile phone model), a CellID, location information of the terminal device in a cellular cell on which the terminal device camps, and a signal status of the cellular cell). For example, when a user moves from one place to another place with a terminal device, the terminal device may report cellular cell information of a plurality of cellular cells on which the terminal device camps to the server through a network device in communication connection with the terminal device during the movement of the terminal device.

Step 602: The server generates a cellular cell location database based on cellular cell information of a plurality of cellular cells that is reported by each terminal device.

In an implementation, the server may summarize cell identifiers of one or more cellular cells on which the terminal device camps and location information of the terminal device in the one or more cellular cells on which the terminal device camps that are reported by each terminal device of the terminal devices, to obtain cell identifiers of a plurality of cellular cells and longitude and latitude ranges of the plurality of cellular cells. For example, for a cell identifier of a same cellular cell, the server may determine longitude and latitude ranges of the cellular cell based on location information of a plurality of terminal devices camping on the cellular cell. Then, the server may store the cell identifiers of the plurality of cellular cells and the longitude and latitude ranges of the plurality of cellular cells into the cellular cell location database.

It should be noted that the cellular cell location database may be updated in real time. For example, the server may update the cellular cell location database in real time based on cellular cell information reported by each terminal device in real time. In addition, the cellular cell location database may alternatively be updated in a specific cycle. For example, the server may update the cellular cell location database based on cellular cell information of one or more cellular cells that is reported by each of the plurality of terminal devices and that is collected within a specific time period (for example, every 15 minutes, every 30 minutes, or every more than 30 minutes).

Step 603: The server obtains longitude and latitude ranges of each subway station area, and matches the longitude and latitude ranges of each subway station area with the cellular cell location database to obtain a first cellular cell set corresponding to the subway scenario.

Optionally, because the terminal device reports only the cell identifier of the cellular cell on which the terminal device camps and the location information of the terminal device in the cellular cell on which the terminal device camps, the terminal device cannot determine, based on the cell identifier of the cellular cell on which the terminal device camps and the location information of the terminal device in the cellular cell on which the terminal device camps, whether the cellular cell on which the terminal device camps is a cellular cell in a subway station area, and cannot determine, based on the first cellular cell set corresponding to the subway scenario, whether the terminal device is in the subway scenario. Therefore, the longitude and latitude ranges of each subway station area needs to be obtained, a Wi-Fi signal fingerprint of each subway station area needs to be obtained, or the like.

In embodiments of this application, a manner of obtaining longitude and latitude ranges of any subway station area includes but is not limited to manual collection, using an existing database, or the like. For example, after the longitude and latitude ranges of each subway station area is manually collected, the collected longitude and latitude ranges of each subway station area is stored, so that the server can obtain the longitude and latitude ranges in time. For another example, the server may alternatively obtain the longitude and latitude ranges of each subway station area from an existing subway station longitude and latitude database (for example, a purchased subway station longitude and latitude database). In addition, the server may alternatively obtain the longitude and latitude ranges of each subway station area from a map database. Certainly, the server may alternatively obtain the ranges in another manner. This is not limited in embodiments of this application.

After the server obtains the longitude and latitude ranges of each subway station area, the server may sequentially match the longitude and latitude ranges of each subway station area with longitude and latitude ranges of each cellular cell in the cellular cell location database, to obtain at least one cellular cell in the subway station area through matching, and summarize cellular cell information of cellular cells in subway station areas. Therefore, the first cellular cell set (including a cellular cell in a ground part of a subway station and a cellular cell in an underground part of the subway station) corresponding to the subway scenario may be obtained.

It should be noted that the server may alternatively perform matching by obtaining a Wi-Fi signal fingerprint of a subway station area, to determine the first cellular cell set corresponding to the subway scenario. Optionally, the server may first generate a subway station Wi-Fi signal fingerprint library based on Wi-Fi signal fingerprints of subway station areas and identifiers of the subway station areas. Then, after receiving a Wi-Fi signal fingerprint and corresponding cellular cell information (for example, a cell identifier of a cellular cell) that are reported by any terminal device, the server may sequentially match the Wi-Fi signal fingerprint with each Wi-Fi signal fingerprint in the subway station Wi-Fi signal fingerprint library, to determine whether the Wi-Fi signal fingerprint belongs to a Wi-Fi signal fingerprint of a subway station area. If the Wi-Fi signal fingerprint belongs to the Wi-Fi signal fingerprint of the subway station area, the server may use the cellular cell reported by the terminal device as a cellular cell of the subway station area. Then, the server may summarize the cellular cell information of the cellular cells in the subway station areas, to obtain the first cellular cell set corresponding to the subway scenario. Certainly, the server may alternatively determine, in another manner, the first cellular cell set corresponding to the subway scenario. This is not limited in embodiments of this application.

Step 604: The server sends the first cellular cell set corresponding to the subway scenario to one or more terminal devices.

The server may actively send the first cellular cell set corresponding to the subway scenario in a specific cycle to the one or more terminal devices. For example, the server may send the generated first cellular cell set corresponding to the subway scenario to the one or more terminal devices at a specified time interval (for example, every 30 seconds, every one minute, or every more than one minute). For another example, the server may send, based on a data obtaining request sent by one or more terminal devices, the first cellular cell set corresponding to the subway scenario to the one or more terminal devices.

Step 605: When determining, based on the first cellular cell set corresponding to the subway scenario, that the terminal device is in the subway scenario, the terminal device generates a cellular cell handover path in a process in which the terminal device moves in the subway scenario.

Optionally, when determining that at least one cellular cell on which the terminal device recently camps is in the first cellular cell set corresponding to the subway scenario, the terminal device may determine that the terminal device is in the subway scenario.

Optionally, to accurately identify whether the terminal device is in the subway scenario, in this case, whether the terminal device continuously passes through m subway station areas needs to be determined based on cell information of a plurality of cellular cells on which the terminal device camps. If the terminal device determines that the terminal device continuously passes through the m subway station areas, it may be determined to a large extent that the terminal device is in the subway scenario.

Optionally, to more accurately determine whether the terminal device is in the subway scenario, the terminal device may alternatively perform comprehensive determining based on the cell information of the plurality of cellular cells on which the terminal device camps and with reference to a movement status of the terminal device.

For example, when determining, based on the cell information of the plurality of cellular cells on which the terminal device camps, that the terminal device continuously passes through the m subway station areas, and determining that the movement status of the terminal device matches a movement status of the terminal device in the subway scenario, the terminal device may more accurately determine that the terminal device is in the subway scenario, to determine that a user to which the terminal device belongs is taking a subway.

Optionally, the terminal device may alternatively generate a cellular cell handover path of the terminal device in a process of moving in the subway scenario based on a cellular cell handover relationship (namely, a handover relationship between cellular cells on which the terminal device camps, for example, handover from one camped cellular cell to another cellular cell for camping) of the terminal device between a departure subway station and a destination subway station in the process of taking the subway by the user to which the terminal device belongs (namely, in a process of taking the subway from the departure subway station to the destination subway station by the user). In addition, in the process of taking the subway by the user to which the terminal device belongs, the terminal device may further identify a signal status (for example, signal quality, signal strength, whether congestion occurs, or whether there is no signal) of each cellular cell on which the terminal device camps, and store the signal status of each cellular cell on which the terminal device camps.

Step 606: The terminal device sends, to the server, the cellular cell handover path generated in the process in which the terminal device moves in the subway scenario.

In an implementation, after generating the cellular cell handover path generated in the process in which the terminal device moves in the subway scenario, the terminal device may send, to the server through the corresponding network device, the cellular cell handover path generated in the process in which the terminal device moves in the subway scenario.

Optionally, when sending the cellular cell handover path to the server through the corresponding network device, the terminal device may also send, to the server through the corresponding network device, cellular cell information of the plurality of cellular cells associated with the cellular cell handover path.

In another implementation, in the process in which the terminal device moves in the subway scenario, if the terminal device performs cellular cell handover (for example, from a cellular cell on which the terminal device camps to another cellular cell for camping), the terminal device may send a handover relationship between the two cellular cells to the server through the corresponding network device. After collecting the handover relationship that is reported by the terminal device and that is between the cellular cells, the server summarizes the handover relationship between the cellular cells, and generates the cellular cell handover path generated in the process in which the terminal device moves in the subway scenario. Optionally, when sending the handover relationship between the two cellular cells to the server through the corresponding network device, the terminal device may also send, to the server through the corresponding network device, cellular cell information of the two cellular cells.

Step 607: The server generates, based on the first cellular cell set corresponding to the subway scenario and cellular cell handover paths of the terminal devices in the subway scenario, a second cellular cell set corresponding to the subway scenario and a cellular cell handover relationship corresponding to the subway scenario.

The second cellular cell set is used by the terminal device to identify whether the terminal device is in the subway scenario. In an implementation, for a cellular cell handover path of each terminal device in the subway scenario, the server first removes a plurality of cellular cells owned by head and tail subway station areas (namely, a departure subway station and a destination subway station of a user to which the terminal device belongs and who takes a subway that belongs to an operation line) in the cellular cell handover path of the terminal device, and determines whether an intersection exists between a cellular cell handover path of the terminal device obtained through removal and the first cellular cell set corresponding to the subway scenario. If there is an intersection set, the server may determine that an intersected cellular cell is a cellular cell that belongs to a subway station (namely, a cellular cell that is of an in-station part of another subway station and that is passed by a user to which the terminal device belongs between the departure subway station and the destination subway station). Optionally, the server may determine that a cellular cell other than an intersected cellular cell in a subway station cellular cell set of another subway station is a cellular cell of an out-of-station part of the another subway station (namely, a cellular cell in a ground part of the another subway station), and may mark the cellular cell in the ground part of the another subway station as a cellular cell outside the subway station.

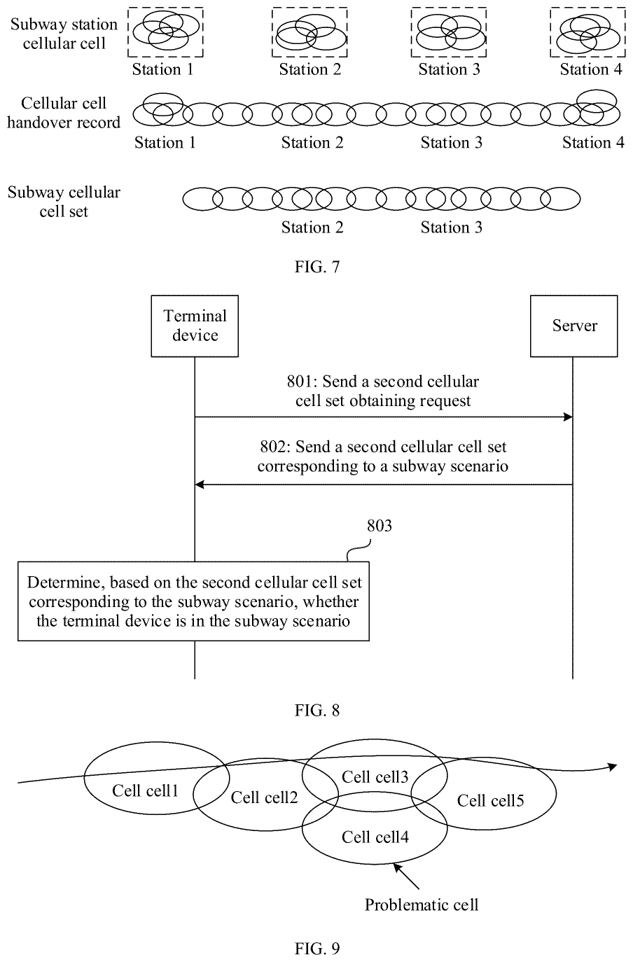

For example, FIG. 7 is a diagram of generating a second cellular cell set corresponding to a subway scenario according to an embodiment of this application. For example, a user takes a subway of an operation line with a terminal device. It is assumed that in a process in which the user moves from a departure subway station to a destination subway station, the user passes through four subway stations in total, which are a station 1 (the departure subway station), a station 2, a station 3, and a station 4 (the destination subway station). Certainly, the terminal device may also report a handover record of cellular cells in a process of moving from the station 1 to the station 4. Then, after removing at least one cell owned by the station 1 and at least one cell owned by the station 4, the server may obtain an intersection between a cell handover path obtained through removal and the first cellular cell set corresponding to the subway scenario, to obtain a cellular cell of an in-station part of the station 2 and a cellular cell of an in-station part of the station 3, and may obtain a cellular cell of an out-of-station part of the station 2 and a cellular cell of an out-of-station part of the station 3. In this way, the server may summarize cellular cell information of each cellular cell existing between the station 1 and the station 2, cellular cell information of each cellular cell existing between the station 2 and the station 3, cellular cell information of each cellular cell existing between the station 3 and the station 4, cellular cell information of at least one cellular cell of the in-station part of the station 2, and cellular cell information of at least one cellular cell of the in-station part of the station 3. In this way, a cellular cell set from station 1 to station 4 for the user may be generated.

Therefore, in the foregoing manner, the server may identify, based on a cellular cell handover path generated when a user to which another terminal device belongs takes a subway belonging to the operation line and the first cellular cell set corresponding to the subway scenario, a cellular cell that belongs to an in-station part of another subway station on the operation line, and a cellular cell that belongs to an out-of-station part of the another subway station on the operation line. Optionally, the server may generate, based on a cellular cell handover path corresponding to a terminal device carried by each user taking a subway of the operation line and a cellular cell of an in-station part of each subway station that belongs to the operation line, a cellular cell handover relationship for the operation line, and may generate a cellular cell set for the operation line based on cellular cell information of a plurality of cellular cells of in-station parts of subway stations belonging to the operation line and cellular cell information of a plurality of cellular cells associated with a cellular cell handover path between any two neighboring subway stations, so that a cellular cell handover relationship corresponding to the subway scenario and the second cellular cell set corresponding to the subway scenario may be generated.

In addition, it should be noted that the server may determine a signal status of a cellular cell in the following manners:

Manner 1: After the server receives a signal status of each cellular cell reported by each terminal device, for each cellular cell, the server collects statistics, on a quantity of terminal devices that report a poor signal status (for example, a weak signal, communication congestion, or no signal) for the cellular cell and a quantity of terminal devices that report a good signal status for the cellular cell, to obtain the quantity of terminal devices that report a poor signal status for the cellular cell and the quantity of terminal devices that report a poor signal status for the cellular cell. If the quantity of terminal devices that report a good signal status for the cellular cell is less than a first quantity threshold, or the quantity of terminal devices that report a poor signal status for the cellular cell is greater than a second quantity threshold, the server may determine that a signal status of the cellular cell is poor. If the quantity of terminal devices that report a good signal status for the cellular cell is greater than or equal to a first quantity threshold, or the quantity of terminal devices that report a poor signal status for the cellular cell is less than or equal to a second quantity threshold, the server may determine that a signal status of the cellular cell is good.

Manner 2: For each cellular cell, the server may collect statistics on a quantitative proportion of terminal devices that report a good signal status for the cellular cell, or the server may collect statistics on a quantitative proportion of terminal devices that report a poor signal status for the cellular cell. If the quantitative proportion of the terminal devices that report a good signal status for the cellular cell is less than a first proportion threshold, or the quantitative proportion of the terminal devices that report a poor signal status for the cellular cell is greater than a second proportion threshold, the server may determine that a signal status of the cellular cell is poor. If the quantitative proportion of the terminal devices that report a good signal status for the cellular cell is greater than or equal to the first proportion threshold, or the quantitative proportion of the terminal devices that report a poor signal status for the cellular cell is less than or equal to the second proportion threshold, the server may determine that the signal status of the cellular cell is good.

Manner 3: For each cellular cell, the server may collect, based on a reporting dimension of a signal status of the cellular cell, statistics on a quantitative proportion of terminal devices having a problem (for example, poor signal quality, a weak signal, communication congestion, or no signal) in a signal status in the reporting dimension. If the quantitative proportion is greater than a third proportion threshold, the server may determine that the signal status of the cellular cell in the reporting dimension is poor. If the quantitative proportion is less than or equal to the third proportion threshold, the server may determine that the signal status of the cellular cell in the reporting dimension is good. Certainly, the server may alternatively collect statistics on a quantitative proportion of terminal devices having no problem in a signal status in the reporting dimension. If the quantitative proportion is greater than or equal to a fourth proportion threshold, the server may determine that the signal status of the cellular cell in the reporting dimension is good. If the quantitative proportion is less than the fourth proportion threshold, the server may determine that the signal status of the cellular cell in the reporting dimension is poor.

A data storage form formed by a cellular cell handover relationship for a subway and a second cellular cell set may be shown in Table 1.

TABLE 1

| | | | | | | |
|---|---|---|---|---|---|---|
| | Cell | | | | | Subway |
| Sequence | infor- | Neighboring | Cell | Time | Signal | station |
| number | mation | cell list | type | period | feature | name |

1
2
. . .

The following describes information in Table 1.
a. The cell information includes but is not limited to a PLMN, a TAC/LAC (Location Area Code), a CellID, a Physical CellID (physical cell identifier), a frequency (for example, a usable frequency of a base station), and the like.
b. The neighboring cell list is a list of neighboring cells of a current cell. In addition to a PLMN, a TAC/LAC, a CellID, a Physical CellID, and a frequency, cell information of each neighboring cell includes a probability of handover from the current cell to the neighboring cell. For example, the current cell is cell1, and the neighboring cells are cell2 and cell3. For the neighboring cell cell2, a probability of handover from the current cell cell1 to the neighboring cell cell2 may be recorded in cell information of the neighboring cell cell2, for example, the probability is 0.6. For the neighboring cell cell3, a probability of handover from the current cell cell1 to the neighboring cell cell3 may also be recorded in cell information of the neighboring cell cell3, that is, the probability is 0.4. In an implementation, a probability of handover from the current cell to the neighboring cell may be determined by collecting statistics on a cellular cell handover path reported by each terminal device. For example, the cell cell1, the cell cell2, and the cell cell3 are used as an example. The cell cell2 and the cell cell3 are neighboring cells of the cell cell1. It is assumed that 10 terminal devices report handover paths for performing handover from the cell cell1 to the cell cell2 or the cell cell3. Cell handover paths reported by five terminal devices are from the cell cell1 to the cell cell2, and cell handover paths reported by five terminal devices are from the cell cell1 to the cell cell3. In this case, it may be determined that a probability of handover from the cell cell1 to the cell cell2 is 0.5, and a probability of handover from the cell cell1 to the cell cell3 is 0.5.
c. The cell type includes a subway cell (for example, a cellular cell in a subway station and a cellular cell between two neighboring subway stations) and a cell outside a subway station.
d. The time period may be flexibly divided. For example, the time period may be divided into a peak period and a non-peak period, or a day may be divided into a plurality of time periods by using X minutes as a division interval.
e. The signal feature may include whether the cell is of weak signal quality, whether communication congestion occurs, whether cell handover fails, whether cell reestablishment or cell reselection fails, and the like.

The following uses an example in which a specific scenario is a subway scenario to describe a specific scenario identification method provided in an embodiment of this application. The method is applicable to the application scenario shown in FIG. 1. Refer to FIG. 8. A procedure of the method includes the following steps.

Step 801: A terminal device sends a second cellular cell set obtaining request to a server.

In an implementation, when the terminal device is in a power-on state or a use state, the terminal device may generate the second cellular cell set obtaining request in a specific cycle, and may send the second cellular cell set obtaining request to the server through a corresponding network device (for example, a base station or a wireless fidelity access point). In another implementation, the terminal device may generate the second cellular cell set obtaining request when identifying that a current location of the terminal device is in a location range of a subway station, and may send the second cellular cell set obtaining request to the server through a corresponding network device (for example, a base station or a wireless fidelity access point). The second cellular cell set obtaining request may be used to request to obtain a second cellular cell set corresponding to one or more specific scenarios. For example, the second cellular cell set obtaining request is used to request to obtain a second cellular cell set corresponding to a subway scenario.

For example, the terminal device locally stores a subway station location range information set. When obtaining the current location of the terminal device through a positioning module, the terminal device may match the current location of the terminal device with the subway station location range information set, and determine whether the current location of the terminal device is within a location range of a subway station. If it is determined that the current location of the terminal device is located within a location range of a subway station, the terminal device may generate the second cellular cell set obtaining request. If it is determined that the current location of the terminal device is not located within a location range of any subway station, the terminal device does not need to generate the second cellular cell set obtaining request.

Optionally, when identifying that a current serving cell of the terminal device is a cellular cell that belongs to an out-of-station part of a subway station, the terminal device may generate the second cellular cell set obtaining request, and may send the second cellular cell set obtaining request to the server through a corresponding network device (for example, a base station or a wireless fidelity access point). For example, the terminal device currently camps on a cellular cell, and the cellular cell is used as a current serving cell of the terminal device. When the terminal device needs to communicate with an external device, the terminal device first establishes a communication connection to a network device in an area in which the cellular cell is located, to implement communication with the external device. The terminal device locally stores a first cellular cell set that corresponds to the subway scenario and that is delivered by the server. In a process of camping on the cellular cell, the terminal device may further sequentially match the cellular cell with each cellular cell in the first cellular cell set corresponding to the subway scenario, to determine whether the cellular cell is a cellular cell that belongs to an out-of-station part of a subway station. If it is determined that the cellular cell is the cellular cell that belongs to the out-of-station part of the subway station, the terminal device generates the second cellular cell set obtaining request. If it is determined that the cellular cell is not the cellular cell that belongs to the out-of-station part of the subway station, the terminal device does not generate the second cellular cell set obtaining request.

The second cellular cell set obtaining request is not only used to indicate that the terminal device requests to obtain, from the server, the second cellular cell set corresponding to the one or more specific scenarios, for example, used to indicate that the terminal device requests to obtain, from the server, the second cellular cell set corresponding to the subway scenario, but also used to indicate that the terminal device requests to obtain, from the server, a cellular cell handover relationship corresponding to the one or more specific scenarios, for example, used to indicate that the terminal device requests to obtain, from the server, a cellular cell handover relationship corresponding to the subway scenario. In addition, the second cellular cell set obtaining request may be further used to indicate that the terminal device requests to obtain, from the server, a communication status record of each cellular cell in an area corresponding to the one or more specific scenarios, for example, used to indicate that the terminal device requests to obtain, from the server, a communication status record of each cellular cell in an area corresponding to the subway scenario. In addition, a specific scenario is a subway scenario is used as an example. The second cellular cell set obtaining request may be further used to indicate that the terminal device requests to obtain, from the server, a cellular cell outside the subway station.

Step 802: The server sends the second cellular cell set corresponding to the subway scenario to the terminal device.

In an implementation, after receiving the second cellular cell set obtaining request sent by the terminal device, the server may deliver the second cellular cell set corresponding to the subway scenario to the terminal device. In another implementation, the server may alternatively deliver the cellular cell handover relationship corresponding to the subway scenario and a communication status of each cellular cell in the area corresponding to the subway scenario to the terminal device, so that the terminal device can identify in time a problematic cell and choose to avoid the problematic cell in the subway scenario, and can select a better cell handover path. In still another implementation, when the terminal device identifies that the terminal device is about to pass through a cellular cell with poor communication experience and cannot select an optimal cellular cell handover path, the terminal device may notify an app installed on the terminal device in advance to adjust a cache policy of the app, to ensure that the app installed on the terminal device can be normally used or to ensure use smoothness of the app installed on the terminal device. For example, an adjustment manner of the cache policy is reducing a bit rate, increasing a cache of the app, or the like. In yet another implementation, step 801 may not be performed. Optionally, when step 801 is not performed, the server may actively send the second cellular cell set corresponding to the subway scenario to the terminal device. For example, the server may send the second cellular cell set corresponding to the subway scenario to the terminal device at a specified time interval (for example, every one day, every two days, or every more than two days), or may send the second cellular cell set corresponding to the subway scenario to the terminal device when the terminal device establishes a communication connection to the server. This is not limited in embodiments of this application.

Step 803: The terminal device determines, based on the second cellular cell set corresponding to the subway scenario, whether the terminal device is in the subway scenario.

In an implementation, the terminal device may sequentially match a current serving cell on which the terminal device camps with each cellular cell in the second cellular cell set corresponding to the subway scenario, and determine whether the current serving cell on which the terminal device camps is a cellular cell in the second cellular cell set corresponding to the subway scenario. If it is determined that the current serving cell on which the terminal device camps is the cellular cell in the second cellular cell set corresponding to the subway scenario, it may be determined to a large extent that the terminal device is in the subway scenario. If it is determined that the current serving cell on which the terminal device camps is not any cellular cell in the second cellular cell set corresponding to the subway scenario, it may be determined that the terminal device is not in the subway scenario.

In another implementation, the terminal device may alternatively determine, based on the second cellular cell set corresponding to the subway scenario and location information of the terminal device, whether the terminal device is in the subway scenario. For example, the terminal device may sequentially match a current serving cell on which the terminal device camps with each cellular cell in the second cellular cell set corresponding to the subway scenario, and determine whether the current serving cell on which the terminal device camps is a cellular cell in the second cellular cell set corresponding to the subway scenario, and may determine whether a current location of the terminal device is within a location range of a subway station. For example, the terminal device may match the current location of the terminal device with a location range of each subway station, to determine whether the current location of the terminal device is within a location range of a subway station. If the terminal device determines that the current serving cell on which the terminal device camps is the cellular cell in the second cellular cell set corresponding to the subway scenario, and the current location of the terminal device is in a location range of a subway station, the terminal device may further accurately determine that the terminal device is in the subway scenario.

Optionally, to further more accurately determine whether the terminal device is in the subway scenario, the terminal device may identify, through a sensor module, a movement status of the terminal device. If the terminal device determines that the current serving cell on which the terminal device camps is the cellular cell in the second cellular cell set corresponding to the subway scenario, and the movement status of the terminal device matches a movement status of the terminal device in the subway scenario, it may be completely determined that the terminal device is in the subway scenario. Optionally, the terminal device may collect an acceleration, an electromagnetic feature, and the like of the terminal device through the sensor module, and may determine the movement status of the terminal device based on the acceleration, the electromagnetic feature, and the like. It should be understood that an acceleration, an electromagnetic feature, and the like of the terminal device in a moving subway are different from those of the terminal device in a scenario in which a user normally walks or runs. In addition, the acceleration, the electromagnetic feature, and the like of the terminal device in the moving subway are also different from those in a moving high-speed railway scenario, a moving vehicle scenario (for example, a moving bus scenario, a moving car scenario, a moving passenger car scenario, a moving van scenario, or a moving truck scenario), a moving ship scenario (for example, a moving fishing boat scenario, a moving transport ship scenario, a moving engineering ship scenario, or a moving speedboat scenario), or the like. Therefore, the terminal device may determine, with reference to the acceleration, the electromagnetic feature, and the like, whether the terminal device is in the subway scenario.

Optionally, to further more accurately determine whether the terminal device is in the subway scenario, after determining that the current serving cell on which the terminal device camps is the cellular cell in the second cellular cell set corresponding to the subway scenario, the terminal device may alternatively start a timer to collect statistics on duration in which the terminal device camps on the cellular cell. When identifying that the terminal device camps on the current serving cell, the terminal device starts the timer to start timing, and when identifying that the terminal device performs handover from the current serving cell to another cellular cell, the terminal device stops timing of the timer. For example, when identifying that the terminal device performs handover from the current serving cell to a cellular cell that does not belong to the second cellular cell set corresponding to the subway scenario, the terminal device stops timing of the timer. Optionally, if the terminal device determines that the duration in which the terminal device camps on the cellular cell is greater than or equal to a duration threshold (for example, 3 minutes, 5 minutes, or more than 5 minutes, which is not specifically limited), the terminal device may determine that the terminal device is in the subway scenario. For example, a user to which a terminal device belongs enters a subway station. It is assumed that there are a plurality of cellular cells in the subway station, and the terminal device camps on one or more cellular cells in the subway station. In this case, duration in which the terminal device camps on the one or more cellular cells may be calculated. In this way, the terminal device may determine, based on the terminal device camping on the one or more cellular cells in the subway station and the duration in which the terminal device camps on the one or more cellular cells, whether the terminal device is actually in the subway scenario, that is, determine whether the user to which the terminal device belongs actually has an intention of taking a subway.

It should be noted that, when it is determined that the terminal device is in the subway scenario, the terminal device may notify each app installed on the terminal device of a situation that the terminal device is in the subway scenario, so that each app can adjust a cache policy of each app in time in a process in which the terminal device is in the subway scenario, to effectively ensure smoothness of using each app in the subway scenario. Optionally, in the process in which the terminal device is in the subway scenario, if the terminal device identifies, based on the cellular cell handover relationship corresponding to the subway scenario and communication status records of a plurality of cellular cells in the area corresponding to the subway scenario, that the terminal device is about to pass through a problematic cell (namely, a cell whose communication quality is lower than a communication quality threshold, which may also be referred to as a cell whose communication quality is poor), for example, a cellular cell with communication congestion or a cellular cell which is fault and is in an end of use state, the terminal device chooses to avoid the problematic cell, and chooses to perform, based on the cellular cell handover relationship corresponding to the subway scenario before cellular cell handover needs to be performed in the subway scenario, handover from the current serving cell to a neighboring cellular cell with good communication quality (namely, a cell whose communication quality is higher than the communication quality threshold), so that the terminal device camps on the neighboring cellular cell with good communication quality. In this way, the terminal device can provide a better communication service for the user.

For example, the terminal device is a mobile phone. When a user takes a subway with a mobile phone, the mobile phone identifies, based on a current serving cell of the mobile phone and a current movement status of the mobile phone, that the mobile phone is in the subway scenario, and may notify in advance each app (for example, an information app, a social app, a game app, an online shopping app, or a video app) installed on the mobile phone of a situation that the mobile phone is currently in the subway scenario. For example, when the user uses the video app on the mobile phone in the subway scenario, because the video app adjusts a cache policy, the user is unaware of video freezing.

FIG. 9 is a diagram in which a terminal device passes through a plurality of cellular cells in a subway scenario according to an embodiment of this application. The following still uses an example in which the terminal device is a mobile phone. When a user takes a subway with a mobile phone, the mobile phone identifies, based on one or more cellular cells on which the mobile phone camps, that the mobile phone is in the subway scenario. In the process in which the mobile phone is in the subway scenario, it is assumed that the mobile phone currently camps on a cellular cell cell2, and then, when the mobile phone identifies, based on a cellular cell handover relationship corresponding to the subway scenario and communication status records of a plurality of cellular cells in an area corresponding to the subway scenario, that the mobile phone is about to pass through a problematic cell cell4, the mobile phone chooses to avoid the problematic cell cell4, and selects an optimal cellular cell handover path based on the cellular cell handover relationship corresponding to the subway scenario. Optionally, in a process in which the user travels by subway with the mobile phone, the mobile phone sequentially performs handover on a cellular cell on which the mobile phone needs to camp from the cellular cell cell2 to a cellular cell cell3, and then from the cellular cell cel13 to a cellular cell cell5. Therefore, it can be effectively ensured that the mobile phone has a good communication signal and can provide a good communication service for the user.

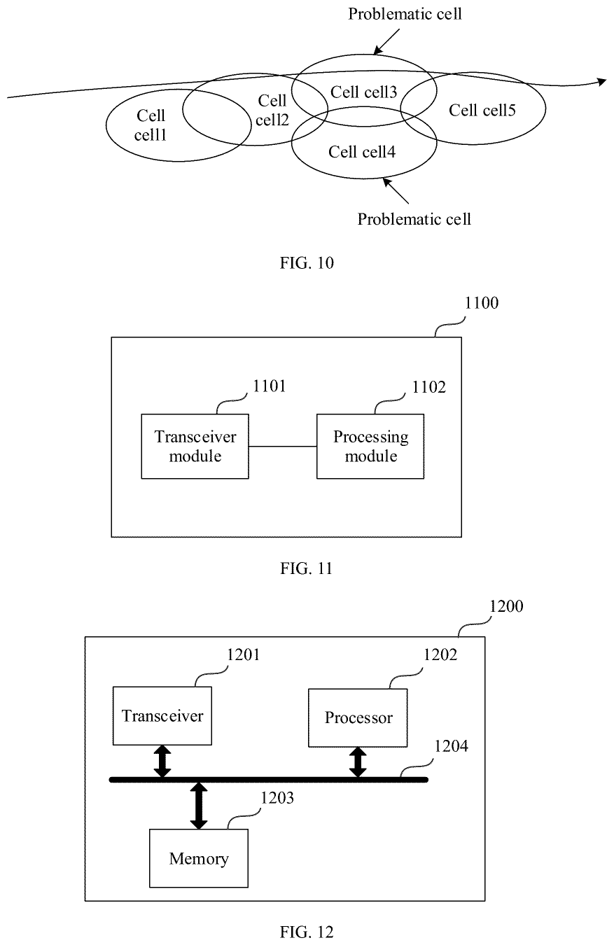

FIG. 10 is another diagram in which a terminal device passes through a plurality of cellular cells in a subway scenario according to an embodiment of this application. The following still uses an example in which the terminal device is a mobile phone. When a user takes a subway with a mobile phone, the mobile phone identifies, based on one or more cellular cells on which the mobile phone camps, that the mobile phone is in the subway scenario. In the process in which the mobile phone is in the subway scenario, it is assumed that the mobile phone currently camps on a cellular cell cell2, and then, when the mobile phone identifies, based on a cellular cell handover relationship corresponding to the subway scenario and communication status records of a plurality of cellular cells in an area corresponding to the subway scenario, that the mobile phone is about to pass through a problematic cell cell3 and a problematic cell cell4. In this case, an optimal cellular cell handover path cannot be selected. The mobile phone may notify, in advance, each app installed on the mobile phone of a situation that the mobile phone is about to pass through problematic cells, so that each app can adjust a cache policy in time, to ensure smooth use of each app by the user in the subway scenario. For example, when the user uses a short video app in the subway scenario, because the mobile phone has notified the short video app of the situation that the mobile phone is in the subway scenario, the short video app has adjusted, in advance, a cache policy in the process in which the terminal device is in the subway scenario. Therefore, when the user uses the short video app to play a short video, the user does not visually perceive frame freezing during short video playing.

In addition, it should be noted that, in a process of determining that the terminal device is in the subway scenario, the terminal device may alternatively identify whether the terminal device leaves the subway scenario. The following describes an implementation process of identifying whether the terminal device leaves the subway scenario.

In an implementation, a scenario in which the terminal device leaves a cellular cell in a second cellular cell set corresponding to the subway scenario and camps on a cellular cell that belongs to an out-of-station part of the subway station is used as an example. Optionally, if the terminal device determines that duration in which the terminal device leaves the cellular cell in the second cellular cell set corresponding to the subway scenario is greater than or equal to a duration threshold T1, the terminal device may determine that the terminal device leaves the subway scenario. For example, it is assumed that the duration threshold T1 is 15 minutes, and the terminal device leaves the cellular cell in the second cellular cell set corresponding to the subway scenario for a period of time (the period of time is greater than or equal to 15 minutes, for example, 18 minutes). In other words, within 18 minutes, the terminal device determines that the terminal device has not camped on one or more cellular cells in the second cellular cell set corresponding to the subway scenario. In this case, the terminal device may determine that the terminal device leaves the subway scenario. Optionally, if it is determined that the duration in which the terminal device leaves the cellular cell in the second cellular cell set corresponding to the subway scenario is less than the duration threshold T1, the terminal device may determine that the terminal device may still be in the subway scenario. For example, it is assumed that the duration threshold T1 is 15 minutes, the terminal device leaves the cellular cell in the second cellular cell set corresponding to the subway scenario and enters a cellular cell that belongs to an out-of-station part of the subway station, and camps on a cellular cell in the second cellular cell set corresponding to the subway scenario for a period of time (for example, 10 minutes) and then re-camps on a cellular cell in the second cellular cell set corresponding to the subway scenario. In this case, the terminal device may determine that the terminal device is also in the subway scenario. To further more accurately determine whether the terminal device is in the subway scenario, the terminal device may further collect statistics on duration in which the terminal device re-camps on the cellular cell in the second cellular cell set corresponding to the subway scenario, and determine whether the duration meets a duration threshold T3. For example, it is assumed that the duration threshold T3 is 3 minutes, and it is assumed that the duration in which the terminal device re-camps on the cellular cell in the second cellular cell set corresponding to the subway scenario is 5 minutes, where the 5 minutes are greater than 3 minutes. In this case, the terminal device may determine that the terminal device is in the subway scenario.

In another implementation, a scenario in which the terminal device leaves a cellular cell in a second cellular cell set corresponding to the subway scenario and camps on a cellular cell that cannot be identified is used as an example. For example, the cellular cell that cannot be identified may belong to a cellular cell of an out-of-station part of the subway station, may belong to a cellular cell of an in-station part of the subway station, may belong to a cellular cell in another area, or the like. Therefore, the terminal device may collect statistics on duration in which the terminal device camps on an unidentified cell after leaving a cell that is in the second cellular cell set corresponding to the subway scenario and that is identified by the terminal device, to further accurately determine whether the terminal device leaves the subway scenario. Optionally, if the terminal device determines that the duration in which the terminal device camps on one or more cellular cells that cannot be identified is greater than or equal to a duration threshold T2, the terminal device may determine that the terminal device leaves the subway scenario. For example, it is assumed that the duration threshold T2 is 10 minutes, and the terminal device camps on the one or more cellular cells that cannot be identified for a period of time (the period of time is greater than or equal to 10 minutes, for example, 12 minutes). In this case, the terminal device may determine that the terminal device leaves the subway scenario. If it is determined that the duration in which the terminal device camps on the one or more cellular cells that cannot be identified is less than the duration threshold T2, the terminal device may determine that the terminal device is still in the subway scenario. For another example, it is assumed that the duration threshold T2 is 10 minutes, and the terminal device camps on the one or more cellular cells that cannot be identified for a period of time (the period of time is less than 10 minutes, for example, 8 minutes), and then re-camps on a cellular cell that belongs to the second cellular cell set. In this case, the terminal device may determine that the terminal device is also in the subway scenario. To further more accurately determine whether the terminal device is in the subway scenario, the terminal device may further collect statistics on duration in which the terminal device re-camps on the cellular cell in the second cellular cell set corresponding to the subway scenario, and determine whether the duration meets the duration threshold T3. For example, it is assumed that the duration threshold T3 is 3 minutes, and it is assumed that the duration in which the terminal device re-camps on the cellular cell in the second cellular cell set corresponding to the subway scenario is 4 minutes, where the 4 minutes are greater than 3 minutes. In this case, the terminal device may determine that the terminal device is in the subway scenario. Alternatively, it is assumed that the duration in which the terminal device re-camps on the cellular cell in the second cellular cell set corresponding to the subway scenario is 2 minutes, where 2 minutes is less than 3 minutes. In this case, the terminal device may determine that the terminal device leaves the subway scenario.

It should be understood that, when the terminal device leaves the subway scenario, a subway optimization solution for the terminal device (for example, in a process in which the terminal device is in the subway scenario, if the terminal device identifies a problematic cell, the terminal device chooses to avoid the problematic cell and selects an optimal cellular cell handover path) does not take effect any more, and the terminal device no longer notifies an app installed on the terminal device to adjust a cache policy.

It should be noted that each step in the foregoing embodiments may be performed by a corresponding device, or may be performed by a component like a chip, a processor, or a chip system in the device. This is not limited in embodiments of this application. The foregoing embodiments are described only by using an example in which steps are executed by corresponding devices.

It should be noted that in the foregoing embodiments, a part of steps may be selected for implementation, or a sequence of steps in the figure may be adjusted for implementation. This is not limited in this application. It should be understood that performing a part of steps in the figure, adjusting a sequence of steps, or combining the two manners for specific implementation shall fall within the protection scope of this application.

It may be understood that, to implement functions in the foregoing embodiments, devices in the foregoing embodiments include corresponding hardware structures and/or software modules for performing the functions. A person skilled in the art should be easily aware that, in this application, the units and method steps in the examples described with reference to embodiments disclosed in this application can be implemented by hardware or a combination of hardware and computer software. Whether a function is performed by hardware or hardware driven by computer software depends on particular application scenarios and design constraint conditions of the technical solutions.

It may be understood that, the application scenario described in embodiments of this application is intended to describe the technical solutions in embodiments of the present invention more clearly, but does not constitute a limitation on the technical solutions provided in embodiments of the present invention. A person of ordinary skill in the art may be aware that, with evolution of the application scenario and emergence of a new service, the technical solutions provided in embodiments of the present invention are also applicable to a similar technical problem.

It should be noted that, in the foregoing embodiments, information transmission between two terminal devices may be implemented by exchanging a sidelink message, and information transmission between two network devices may be implemented by exchanging Xn signaling. Information transmission between a terminal device and a network device may be implemented based on RRC signaling or an air interface message. In conclusion, each information transmission and each message transmission in the foregoing embodiments may be replaced with other messages based on an actual requirement.

It should be noted that the “step” in embodiments of this application is merely an example, which is a representation method used to better understand embodiments, and does not constitute a substantive limitation on execution of the solutions in this application. For example, the “step” may also be understood as a “feature”. In addition, the step does not constitute any limitation on an execution sequence of the solutions in this application, and a new technical solution formed through an operation, for example, step sequence change, step combination, or step splitting, performed on this basis without affecting implementation of the overall solutions also falls within the scope disclosed in this application.

Based on a same technical concept, an embodiment of this application further provides a possible terminal device. The terminal device 1100 is applicable to the application scenario shown in FIG. 1. The terminal device 1100 is configured to implement the method provided in the foregoing embodiments, or a module (for example, a chip) of the terminal device 1100 is configured to implement the method provided in the foregoing embodiments. Therefore, beneficial effect of the foregoing embodiments can also be implemented. In embodiments of this application, the terminal device 1100 may be the terminal device 200 shown in FIG. 1.

As shown in FIG. 11, the terminal device 1100 includes a transceiver module 1101 and a processing module 1102. The transceiver module 1101 is configured to receive, from a server, a first cellular cell set corresponding to a first specific scenario. The first specific scenario includes n first areas, n is an integer greater than or equal to 2, and the first cellular cell set includes cell information of a plurality of cells in each of the n first areas. The processing module 1102 is configured to: when identifying, based on cell information of a plurality of cells on which the terminal device camps, that the terminal device continuously passes through m first areas, determine that the terminal device is in the first specific scenario, where m is an integer greater than or equal to 2. The processing module 1102 is further configured to control the transceiver module 1101 to report, to the server, cell information of a plurality of cells on which the terminal device camps after determining that the terminal device is in the first specific scenario.

For more detailed descriptions of the transceiver module 1101 and the processing module 1102, refer to related descriptions in the foregoing method embodiments. Details are not described herein again.

It should be understood that the transceiver module 1101 in this embodiment of this application may be implemented by a transceiver or a transceiver-related circuit component, and the processing module 1102 may be implemented by a processor or a processor-related circuit component.

It should be noted that division into the modules in embodiments of this application is an example, and is merely logical function division. In actual implementation, there may be another division manner. In addition, function units in embodiments of this application may be integrated into one processing unit, or may exist alone physically, or two or more units may be integrated into one unit. The integrated unit may be implemented in a form of hardware, or may be implemented in a form of a software function unit.

When the integrated unit is implemented in the form of the software function unit and sold or used as an independent product, the integrated unit may be stored in a computer-readable storage medium. Based on such an understanding, the technical solutions of this application essentially, or the part contributing to the current technology, or all or some of the technical solutions may be implemented in a form of a software product. The computer software product is stored in a storage medium, and includes several instructions for instructing a computer device (which may be a personal computer, a server, a network device, or the like) or a processor to perform all or some of the steps of the methods in embodiments of this application. The foregoing storage medium includes any medium that can store program code, such as a USB flash drive, a removable hard disk, a read-only memory (ROM), a random access memory (RAM), a magnetic disk, or an optical disc.

Based on a same concept, an embodiment of this application further provides a possible terminal device. The terminal device 1200 is applicable to the application scenario shown in FIG. 1. The terminal device 1200 is configured to implement the method provided in the foregoing embodiments. Therefore, beneficial effect of the foregoing method embodiments can also be implemented. Refer to FIG. 12. The terminal device 1200 includes a transceiver 1201 and a processor 1202. Optionally, the terminal device further includes a memory 1203. The transceiver 1201, the processor 1202, and the memory 1203 are connected to each other. When the terminal device 1200 is configured to implement the method provided in the foregoing embodiments, the transceiver 1201 is configured to implement a function of the transceiver module 1101, and the processor 1202 is configured to implement a function of the processing module 1102.

Optionally, the transceiver 1201, the processor 1202, and the memory 1203 are connected to each other through a bus 1204. The bus 1204 may be a peripheral component interconnect (PCI) bus, an extended industry standard architecture (EISA) bus, or the like. The bus may be classified into an address bus, a data bus, a control bus, or the like. For ease of representation, only one thick line is used to represent the bus in FIG. 12, but this does not mean that there is only one bus or only one type of bus.

The transceiver 1201 is configured to receive and send data, to implement communication with another device in the application scenario shown in FIG. 1. Optionally, the transceiver 1201 may include a communication interface or an input/output interface. For example, the terminal device may communicate with a network device through the communication interface, or the terminal device may communicate with another terminal device through the communication interface.

For a function of the processor 1202, refer to the descriptions in the foregoing embodiments. Details are not described herein again. The processor 1202 may be a central processing unit (CPU), a network processor (NP), a combination of a CPU and an NP, or the like. The processor 1202 may further include a hardware chip. The hardware chip may be an application-specific integrated circuit (ASIC), a programmable logic device (PLD), or a combination thereof. The PLD may be a complex programmable logic device (CPLD), a field programmable gate array (FPGA), a generic array logic (GAL), or any combination thereof. The processor 1202 may implement the foregoing functions by hardware or certainly by hardware executing corresponding software.

The memory 1203 is configured to store program instructions and the like. Specifically, the program instructions may include program code, and the program code includes computer operation instructions. The memory 1203 may include a random access memory (RAM), or may include a non-volatile memory, for example, at least one magnetic disk memory. The processor 1202 executes the program instructions stored in the memory 1203, to implement the function, so as to implement the method provided in the foregoing embodiments.

Based on a same concept, an embodiment of this application further provides a computer program product. The computer program product includes a computer program or instructions. When the computer program or the instructions are run on a computer, the computer is enabled to perform the method provided in the foregoing embodiments.

Based on a same concept, an embodiment of this application further provides a computer-readable storage medium. The computer-readable storage medium stores a computer program or instructions. When the computer program or the instructions are run on a computer, the computer is enabled to perform the method provided in the foregoing embodiments.

The storage medium may be any usable medium that can be accessed by the computer. The following provides an example but does not impose a limitation: The computer-readable medium may include a RAM, a ROM, an EEPROM, a CD-ROM, or another optical disc storage or disk storage medium, or another magnetic storage device, or any other medium that can carry or store expected program code in a form of an instruction or a data structure and can be accessed by a computer.

Based on a same concept, an embodiment of this application further provides a chip. The chip is coupled to a memory, and the chip is configured to read a computer program stored in the memory, to implement the method provided in the foregoing embodiments.

Based on a same concept, an embodiment of this application further provides a chip system. The chip system includes a processor, configured to support a computer apparatus in implementing a function related to the terminal device in the foregoing embodiments. In a possible design, the chip system further includes a memory, and the memory is configured to store a program and data that are necessary for the computer apparatus. The chip system may include a chip, or may include a chip and another discrete component.

All or some of the methods in embodiments of this application may be implemented by using software, hardware, firmware, or any combination thereof. When software is used to implement the foregoing embodiments, all or some of embodiments may be implemented in a form of a computer program product. The computer program product includes one or more computer instructions. When the computer instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a high-density digital video disc (DVD)), a semiconductor medium (for example, a solid-state drive (SSD)), or the like.

Steps of the methods described in embodiments of this application may be directly embedded into hardware, a software unit executed by the processor, or a combination thereof. The software unit may be stored in a RAM, a ROM, an EEPROM, a register, a hard disk drive, a removable magnetic disk, a CD-ROM, or a storage medium of any other form in the art. For example, the storage medium may connect to a processor, so that the processor may read information from the storage medium and write information to the storage medium. Optionally, the storage medium may alternatively be integrated into the processor. The processor and the storage medium may be disposed in an ASIC.

These computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more processes in flowcharts and/or in one or more blocks in block diagrams.

It is clearly that a person skilled in the art can make various modifications and variations to this application without departing from the spirit and scope of this application. In this way, this application is intended to cover these modifications and variations of this application provided that they fall within the scope of protection defined by the following claims and their equivalent technologies.

1. A data processing method, wherein the method comprises:
receiving, from a server, a first cellular cell set corresponding to a first specific scenario, wherein the first specific scenario comprises n first areas, n is an integer greater than or equal to 2, and the first cellular cell set comprises cell information of a plurality of cells in each of the n first areas;
when identifying, based on cell information of a plurality of cells on which a terminal device camps, that the terminal device continuously passes through m first areas, determining that the terminal device is in the first specific scenario, wherein m is an integer greater than or equal to 2; and
reporting, to the server, cell information of a plurality of cells on which the terminal device camps after determining that the terminal device is in the first specific scenario.

2. The method according to claim 1, wherein the determining that the terminal device is in the first specific scenario comprises:
determining a first movement feature of the terminal device; and
when identifying, based on the cell information of the plurality of cells on which the terminal device camps, that the terminal device continuously passes through the m first areas, and the first movement feature matches a movement feature of the terminal device in the first specific scenario, determining that the terminal device is in the first specific scenario.

3. The method according to claim 1, wherein after the reporting, to the server, cell information of a plurality of cells on which the terminal device camps after determining that the terminal device is in the first specific scenario, the method further comprises:
receiving a second cellular cell set from the server, wherein the second cellular cell set comprises cell information of a plurality of cells in an area corresponding to a second specific scenario;
obtaining cell information of a first cell on which the terminal device currently camps; and
when the second cellular cell set comprises the cell information of the first cell, determining that the terminal device is in the second specific scenario.

4. The method according to claim 3, wherein the determining that the terminal device is in the second specific scenario comprises:
determining a current physical location of the terminal device; and
when the second cellular cell set comprises the cell information of the first cell, and the physical location belongs to the area corresponding to the second specific scenario, determining that the terminal device is in the second specific scenario.

5. The method according to claim 3, wherein the determining that the terminal device is in the second specific scenario comprises:
determining a current second movement feature of the terminal device; and
when the second cellular cell set comprises the cell information of the first cell, and the second movement feature matches a movement feature of the terminal device in the second specific scenario, determining that the terminal device is in the second specific scenario.

6. The method according to claim 3, wherein the determining that the terminal device is in the second specific scenario comprises:
determining first duration in which the terminal device camps on the first cell; and
when the second cellular cell set comprises the cell information of the first cell, and the first duration is greater than a first duration threshold, determining that the terminal device is in the second specific scenario.

7. The method according to claim 3, wherein after the determining that the terminal device is in the second specific scenario, the method further comprises:
caching service data according to a cache policy corresponding to the second specific scenario.

8. The method according to claim 3, wherein after the determining that the terminal device is in the second specific scenario, the method further comprises:
determining, based on a cell handover path corresponding to the second specific scenario, that the terminal device is to perform handover to a second cell;
when determining, based on communication status records of the plurality of cells in the area corresponding to the second specific scenario, that the second cell is a cell whose communication quality is lower than a communication quality threshold, determining, from a plurality of cells adjacent to the first cell on which the terminal device currently camps, a third cell whose communication quality is higher than the communication quality threshold; and
performing handover to the third cell.

9. The method according to claim 3, wherein after the determining that the terminal device is in the second specific scenario, the method further comprises:
after the terminal device performs handover from the first cell to a fourth cell, obtaining cell information of the fourth cell;
when the second cellular cell set does not comprise the cell information of the fourth cell or the cell information of the fourth cell is not obtained, starting a timer, wherein the timer is used to count second duration in which the terminal device is not identified as being in the second specific scenario; and
when the second duration is greater than a second duration threshold, determining that the terminal device leaves the second specific scenario.

10. The method according to claim 9, wherein the method further comprises:
when the terminal device performs handover from the fourth cell to a fifth cell, if the second cellular cell set comprises cell information of the fifth cell, stopping timing of the timer; or if the second cellular cell set does not comprise cell information of the fifth cell or the cell information of the fifth cell is not obtained, continuing timing of the timer.

11. The method according to claim 3, wherein the second cellular cell set is generated by the server based on the cell information of the plurality of cells in the area corresponding to the second specific scenario, and the plurality of cells in the area corresponding to the second specific scenario are determined by the server based on the first cellular cell set and a cell handover path reported by at least one terminal device after it is determined that the at least one terminal device is in the second specific scenario.

12. The method according to claim 3, wherein both the first specific scenario and the second specific scenario are subway scenarios, and the first area is a subway station area.

13. A terminal device, comprising:
at least one processor; and
a non-transitory computer-readable storage medium coupled to the at least one processor and storing programming instructions for execution by the at least one processor, the programming instructions, when executed, instruct the at least one processor to:
receive, from a server, a first cellular cell set corresponding to a first specific scenario, wherein the first specific scenario comprises n first areas, n is an integer greater than or equal to 2, and the first cellular cell set comprises cell information of a plurality of cells in each of the n first areas;
when identifying, based on cell information of a plurality of cells on which the terminal device camps, that the terminal device continuously passes through m first areas, determine that the terminal device is in the first specific scenario, wherein m is an integer greater than or equal to 2; and
report, to the server, cell information of a plurality of cells on which the terminal device camps after determining that the terminal device is in the first specific scenario.

14. The terminal device according to claim 13, wherein the determine that the terminal device is in the first specific scenario comprises:
determine a first movement feature of the terminal device; and
when identifying, based on the cell information of the plurality of cells on which the terminal device camps, that the terminal device continuously passes through the m first areas, and the first movement feature matches a movement feature of the terminal device in the first specific scenario, determine that the terminal device is in the first specific scenario.

15. The terminal device according to claim 13, wherein after the report, to the server, cell information of a plurality of cells on which the terminal device camps after determining that the terminal device is in the first specific scenario, the programming instructions further instruct the at least one processor to:
receive a second cellular cell set from the server, wherein the second cellular cell set comprises cell information of a plurality of cells in an area corresponding to a second specific scenario;
obtain cell information of a first cell on which the terminal device currently camps; and
when the second cellular cell set comprises the cell information of the first cell, determine that the terminal device is in the second specific scenario.

16. The terminal device according to claim 15, wherein the determine that the terminal device is in the second specific scenario comprises:
determine a current physical location of the terminal device; and
when the second cellular cell set comprises the cell information of the first cell, and the physical location belongs to the area corresponding to the second specific scenario, determine that the terminal device is in the second specific scenario.

17. The terminal device according to claim 15, wherein the determining that the terminal device is in the second specific scenario comprises:
determine a first duration in which the terminal device camps on the first cell; and
when the second cellular cell set comprises the cell information of the first cell, and the first duration is greater than a first duration threshold, determine that the terminal device is in the second specific scenario.

18. The terminal device according to claim 15, wherein after the determine that the terminal device is in the second specific scenario, the programming instructions further instruct the at least one processor to:
cache service data according to a cache policy corresponding to the second specific scenario.

19. The terminal device according to claim 15, wherein after the determine that the terminal device is in the second specific scenario, the programming instructions further instruct the at least one processor to:
determine, based on a cell handover path corresponding to the second specific scenario, that the terminal device is to perform handover to a second cell;
when determining, based on communication status records of the plurality of cells in the area corresponding to the second specific scenario, that the second cell is a cell whose communication quality is lower than a communication quality threshold, determine, from a plurality of cells adjacent to the first cell on which the terminal device currently camps, a third cell whose communication quality is higher than the communication quality threshold; and
perform handover to the third cell.

20. The terminal device according to claim 15, wherein after the determine that the terminal device is in the second specific scenario, the programming instructions further instruct the
at least one processor to:
after the terminal device performs handover from the first cell to a fourth cell, obtain cell information of the fourth cell;
when the second cellular cell set does not comprise the cell information of the fourth cell or the cell information of the fourth cell is not obtained, start a timer, wherein the timer is used to count second duration in which the terminal device is not identified as being in the second specific scenario; and
when the second duration is greater than a second duration threshold, determine that the terminal device leaves the second specific scenario.
